(19) United States
(12) Patent Application Publication
(10) Pub. No.: US 2018/0227369 A1
(43) Pub. Date: Aug. 9, 2018

(54) CONVERGED SERVICE COMPUTING PLATFORM

(71) Applicant: Kaiser Foundation Hospitals, Oakland, CA (US)

(72) Inventors: Nathan DuCray, Oakland, CA (US); Karl Erich Fankhauser, San Ramon, CA (US); Trevor Hogberg, Walnut Creek, CA (US); Ganesh Thondikulam, Pleasanton, CA (US); Ray Otsuka, Dublin, CA (US)

(73) Assignee: Kaiser Foundation Hospitals, Oakland, CA (US)

(21) Appl. No.: 15/429,051

(22) Filed: Feb. 9, 2017

(51) Int. Cl. H04L 29/08; G06F 19/00; G06F 9/455; H04L 12/28

(52) U.S. Cl. CPC H04L 67/141; G06F 19/327; G06F 9/45558; G06F 2009/45562; H04L 67/1097; H04L 12/2803; G06F 2009/45595; H04L 67/306

(57) ABSTRACT

Systems, methods, and computer program products related to scalable converged service computing systems for use in user-personalized areas within facilities to automate workflow management, and that may be implemented in on-premises physical appliances or public, private, managed or hybrid cloud infrastructure are disclosed. In one embodiment, a scalable computing system for facilities of large enterprises is disclosed, comprising a scalable number of room compute containers each associated with a physical area of a facility, where the room compute container includes capabilities to add sensors, devices and controllers, and mediate and orchestrate interactions between devices and sensors in the room with facility level applications and services to personalize the user experience. In another embodiment, the scalable computing system comprises a converged service computing system for integrating enterprise services with room controls, devices, sensors and monitors in a patient room in a health care facility.

### BACKGROUND

This disclosure relates generally to scalable, modular computing platforms that may be implemented in a variety of environments, from on premises compute facilities to public, private, managed or hybrid cloud infrastructure; and particularly to scalable computing systems and methods for use by an enterprise in connecting disparate devices used in rooms or areas within facilities of the enterprise to users and to facilities and application services of the enterprise.

The quantity and variety of different devices and technologies used in many buildings, businesses, public facilities and modern urban environments in modern society has reached a saturation point. Security cameras, radio-frequency identification (RFID) trackers, biometric sensors, automated lighting controls, smart phones, tablet devices, and video displays, and wearable devices are among the many types of devices deployed in buildings and facilities in a variety of industries.

### SUMMARY

Having a scalable system to host and integrate numerous and diverse devices and technologies deployed within a facility will enable large companies having facilities dispersed across multiple regions to deploy new technology more efficiently and robustly to individual physical areas of the facilities. Such a scalable system may be used in many different contexts, such as building automation, facilities management and health care. For example, in the health care industry context, devices and technologies compete for limited infrastructure and space in health care facilities such as hospitals, medical buildings, rehabilitation facilities, skilled nursing facilities, and in-home based medical care. In the health care facility context, such devices and systems can have a diversity of functions including electronic health records (EHR), building management systems (BMS), infection control systems, patient monitoring systems, fall detection and prevention, and interactive patient care or telemedicine (IPC). Such devices and systems can be mutually exclusive in operation, such as a building control system and an environmental control system for patient care, and can be costly and difficult to integrate into a facility-wide management system.

Therefore, a need exists for a scalable converged service computing system for use within facilities of large and small enterprises, that can supply compute resources (e.g., storage, processors, and memory) that can be allocated to different physical areas of a facility, as well as to various applications or functions within an organization. Such a scalable computing system may be allocated in “slices” of compute, processor and memory resources, for example as a plug-in appliance, and may be installed with application software, such as systems administration applications, profiles and preferences, control management, facilities services management, RFID and real time location sensing (RTLS), and cloud management. Such a plug-in appliance may be deployed to an individual physical area within a facility, where the plug-in appliance functions by integrating messages from disparate devices and sensors, mediating and orchestrating interactions between devices, and converging into a unified user experience.

Embodiments of the present invention described below may be used, for example, to integrate the numerous devices used in a facility, such as biometric, motion and other sensors, monitors, and lighting and temperature controls with systems in conference rooms, lobbies, laboratories, offices or other spaces in various facilities or elsewhere into an interactive, networked system that may be implemented on-premises using physical appliances, or in public, private, managed or hybrid cloud infrastructures, Aspects of the converged service computing platform of the present invention are analogous to how a smartphone serves as a single client device platform for deploying multiple and diverse networked mobile user applications. Integrating these numerous devices of a converged service computing system into a unified platform simplifies system upgrades and maintenance and reduces infrastructure costs, as well as provides a single point of integration for each service onto the common platform. Providing a single point of integration via platform APIs simplifies the process of adding capabilities and services to each individual physical area within an organization's facilities, reducing the need for devices from competing vendors to integrate with each other. Sensing systems integrated into a unified platform may also provide integrated environmental analytics for building automation and facilities management. Some embodiments of the present invention may be designed to provide a unified enterprise platform for deploying multiple diverse devices and systems in patient rooms and other areas within the specific context of a health care facility.

Although embodiments of the present invention are described below in the context of a health care facility, the converged service computing platform as described may be implemented in any of a variety of facilities to integrate disparate sensor and devices installed in and/or used within a facility with systems for building automation, environmental control, facilities scheduling and other functions.

### BRIEF DESCRIPTION OF THE DRAWINGS

The novel features of the invention are set forth in the appended claims. However, for purposes of explanation, several aspects of some embodiments of the invention are described by reference to the following figures.

FIG. 1 illustrates a system according to an embodiment of the present invention.

FIG. 1A illustrates a scalable networked system according to an embodiment of the present invention.

FIG. 2 illustrates an exemplary application layer according to an embodiment of the present invention.

FIG. 3 illustrates an exemplary enterprise infrastructure layer according to an embodiment of the present invention.

FIG. 4 illustrates an exemplary facilities infrastructure layer according to an embodiment of the present invention.

FIG. 4A illustrates an exemplary technology infrastructure layer according to an embodiment of the present invention.

FIG. 5 is a flowchart of an embodiment of a method of device registration of the present invention.

FIG. 6 is a flowchart of an embodiment of a method of device context switching of the present invention.

FIG. 6A illustrates a device context switching system according to an embodiment of the present invention.

FIG. 7 is a flowchart of an embodiment of a method of application switching of the present invention.

FIG. 8 is a flowchart of an embodiment of a method of a business context driven autonomous pattern of the present invention.

FIG. 9 is a flowchart of an embodiment of a method of device control passing of the present invention.

FIG. 10 illustrates a logical diagram for an environmental control system according to an embodiment of the present invention.

### DETAILED DESCRIPTION

The following description is presented to enable any person skilled in the art to make and use embodiments of the invention, and is provided in the context of particular applications and their requirements. Various modifications to the exemplary embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles and features disclosed herein.

Embodiments of the present invention include a converged service computing platform that may be implemented as a scalable plug-in appliance that provides infrastructure, system administration, and application software, supplies compute resources (e.g., storage, CPU, and memory) to a facility, may be allocated to individual physical areas of the facility, and is capable of connecting devices, controllers and sensors that may be found within various physical areas of a facility, which may be administered by a user at the display and control level. The platform incorporates an administration module and security capabilities, integration capabilities from a service bus to pass messages from disparate devices and sensors, mediate and orchestrate interactions between devices through protocol management services which help the devices to communicate with each other such as via RFID/RTLS, cloud management, and control manager, and integrate the user experience through the use of application programming interfaces (APIs).

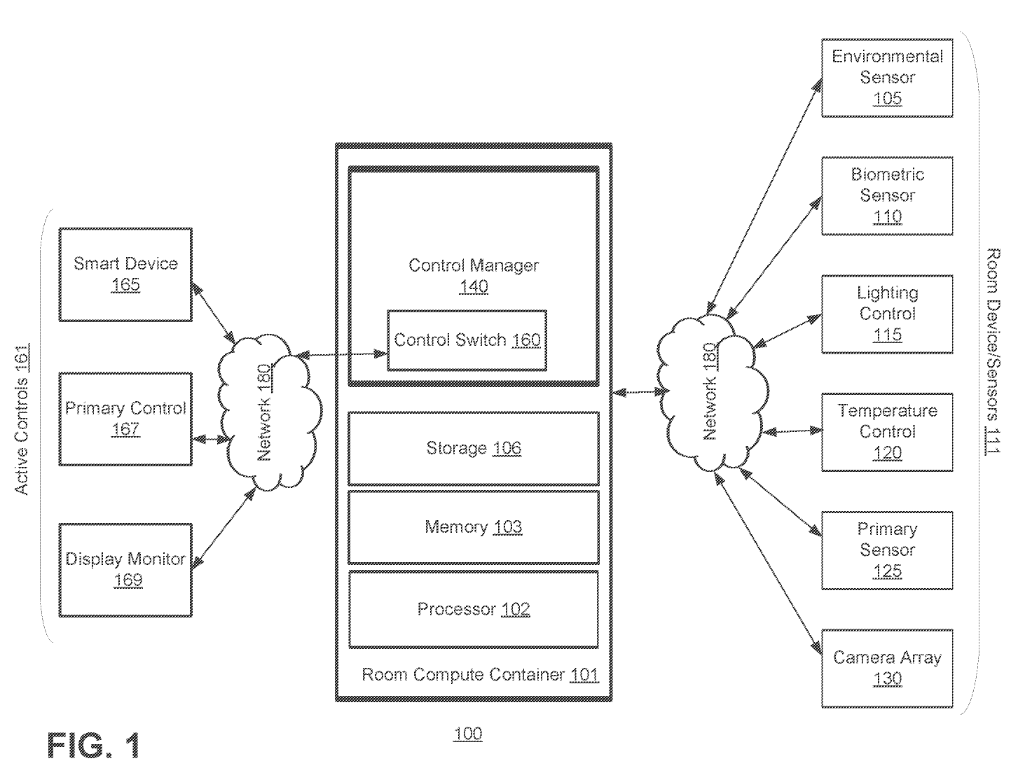

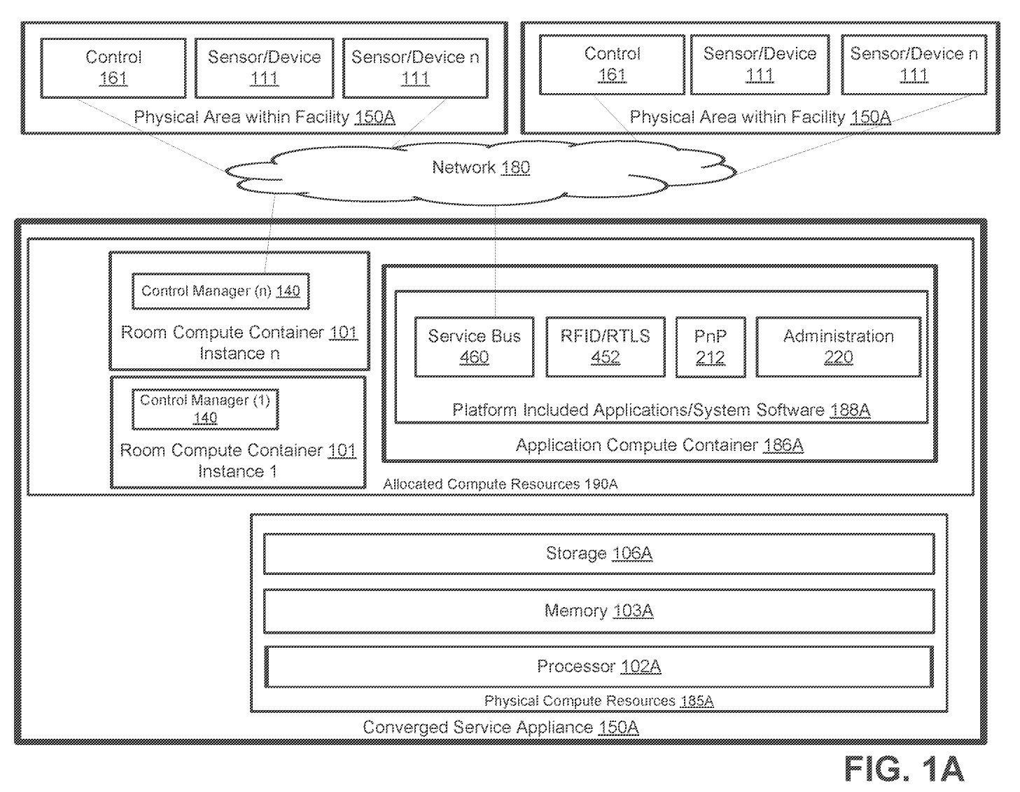

A goal of the converged service computing platform as set forth in embodiments of the present invention is to deliver a scalable computing solution to the facility. In an embodiment of the present invention, compute and network resources are provided by the converged service appliance consolidating scalable compute and application resources that can be allocated to physical spaces within a facility. As set forth in embodiments of the present invention, system 100 as shown in FIG. 1 includes a converged service computing system, such as room compute container 101, that is scalable and configurable to specific areas within a facility as needed to support users in many varied environments. The converged service appliance may be targeted to large scale deployments with dozens, hundreds or thousands of endpoints. In other embodiments of the present invention, the facility cloud infrastructure can be implemented using Embodiments of the present invention cover many potential configurations of compute and network resources that may be allocated to a converged service appliance implementation, such as utility computing infrastructure, a cloud-based Infrastructure as a Service (IaaS), or hybrid cloud approaches. Configurations of compute and network resources may include purely on premise implementations, to purely public, managed or private cloud implementations, as well as permutations of the above in hybrid cloud implementations. Although the converged service computing platform and system software and application components may be delivered in a physical form or via a cloud environment, the association between physical assets such as sensors, devices and controllers and virtual computing assets implemented in a cloud computing environment is a foundational element of the system design.

Systems described in embodiments of the present invention can provide a converged service computing platform that can spawn instances, configured to specific rooms, areas or functional locations within a facility, as needed to support users in various environments. In one embodiment of the present invention, the environment may be related to a health care facility, and can include specific functional locations such as an operating room or an intensive care patient room or unit, as well as less critical locations such as waiting rooms, cafeterias and other public spaces within a hospital. Additionally, in a health care setting, medical office buildings and patient homes may be supported remotely. Furthermore, although embodiments of the present invention may be discussed in the context of the health care industry, they are not limited to implementations in the health care industry, and similar appliances and cloud or hybrid cloud infrastructures may be applied to office buildings and manufacturing facilities of various types.

FIG. 1 shows a converged service computing system 100 in accordance with an embodiment of the present invention. Converged service computing system 100 includes room compute container 101 which includes control manager 140, room endpoint 150, processor 102, storage 106 and memory 103. Applications may be accessed through active controls, including smart device 165, primary control 167 and display monitor 169, which may be activated as the controller via control switch 160. Some applications may be accessed via a common user interface such as a native user interface, or by integrating several APIs together into customer user experiences utilizing a complete responsive web design stack included as part of a comprehensive platform. For example, room devices and sensors 111 such as primary sensor 125, environmental sensor 105, biometric sensor 110, and camera array 130 may measure and assess a user's environment, while environmental controls, such as lighting control 115, automated blinds controls (not shown in FIG. 1), and temperature control 120, allow users to control and adjust their environment (lights, blinds, temperature) to ensure that the environment is suitable to their needs. The comprehensive platform integrates the UI and controls layer with one or more backend controls systems (accessed via network 180) via a service control manager 140 to facilitate a seamless user experience. As shown above, environmental controls may be accessed by the user via active controls. System 100 may track a user's (such as a patient's) profile and preferences so that settings, such as environmental settings, are retained in memory 103 and recalled as needed. These settings can work in conjunction with a user's location to bring a user's settings and preferences to a new location.

Users may also have access to a wide variety of applications, education and entertainment media, which may be brought into the user's experience via system 100 and may be controlled with any of a variety of active control devices 161, such as a touch screen, keyboard or touchpad, or remote control (not shown), or pointer devices such as smart device 165 (which may be a smart phone, tablet device, laptop or notebook computer, or other portable computing device), primary control 167 (which may include remote control device functionality) and display monitor 169 (which may include a touch screen for receiving input from a user). System 100 may be deployed in a diverse array of facility environments, including health care facilities, manufacturing facilities, office buildings, etc. In one embodiment of the present invention, the environment may be related to a health care facility, and can include specific functional locations such as an operating room or an intensive care patient room or unit, as well as less critical locations such as waiting rooms, cafeterias and other public spaces within a hospital. Additionally, in a health care setting, medical office buildings and patient homes may be supported remotely. A user may view educational and entertainment videos on display monitor 169. In addition, video interaction for medical consultations, meetings, or remote monitoring can be integrated into system 100. In addition, in some embodiments, system 100 includes multimodal communication capabilities that support text, voice and video communications for the user over network 180.

In some embodiments of the present invention, where system 100 interacts with a user, a display mechanism and one or more control mechanisms are supported. Control mechanisms can range from a touch screen monitor (such as display monitor 169), to a mouse type cursor input device (not shown in FIG. 1), to a primary control 167, to a user's tablet or smart phone such as smart device 165 (which could include a personal device belonging to a patient in a health care facility, a visitor to a hospital or office building, or a worker in an office building or manufacturing facility, or alternatively a smart phone or tablet device that may be owned by the facility for employee use). In addition to supporting the connection of devices and display monitors in a physical area within a facility to network 180, the platform (as shown in system 100) provides compute, applications, and systems software resources that can be allocated to an individual room or area, a collection of rooms, or to one or more common areas within a facility. Rooms and areas may be used interchangeably when describing embodiments of the present invention, and may be used to describe a portion of subsection of an overall facility, where a collection of controls, monitors, sensors and other devices are grouped together. In some embodiments of the present invention, controls are allocated to an area within a facility and the results of commands issued by a control device are displayed to one or more monitors within that area, but not all areas within the facility.

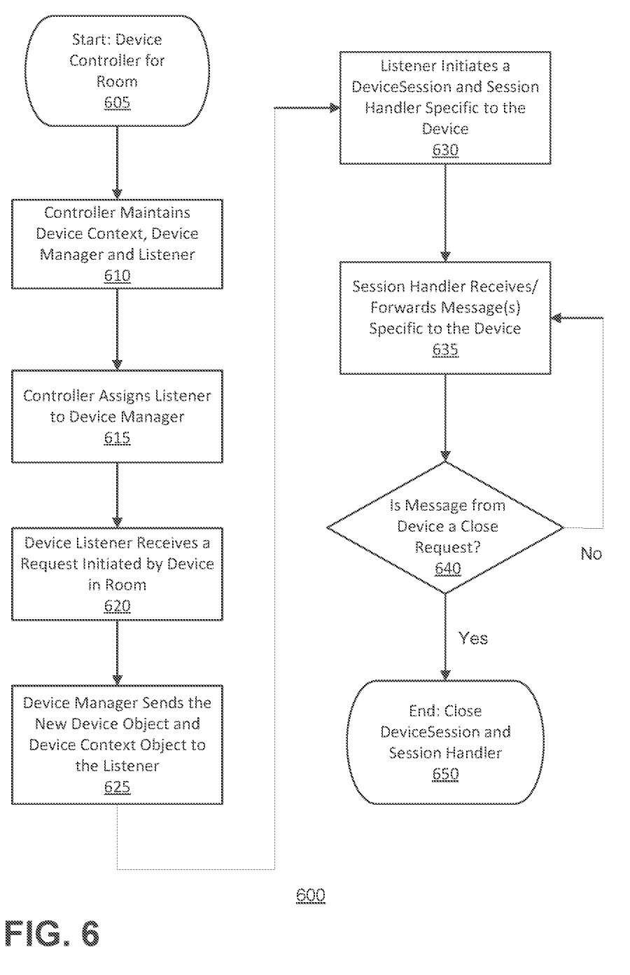

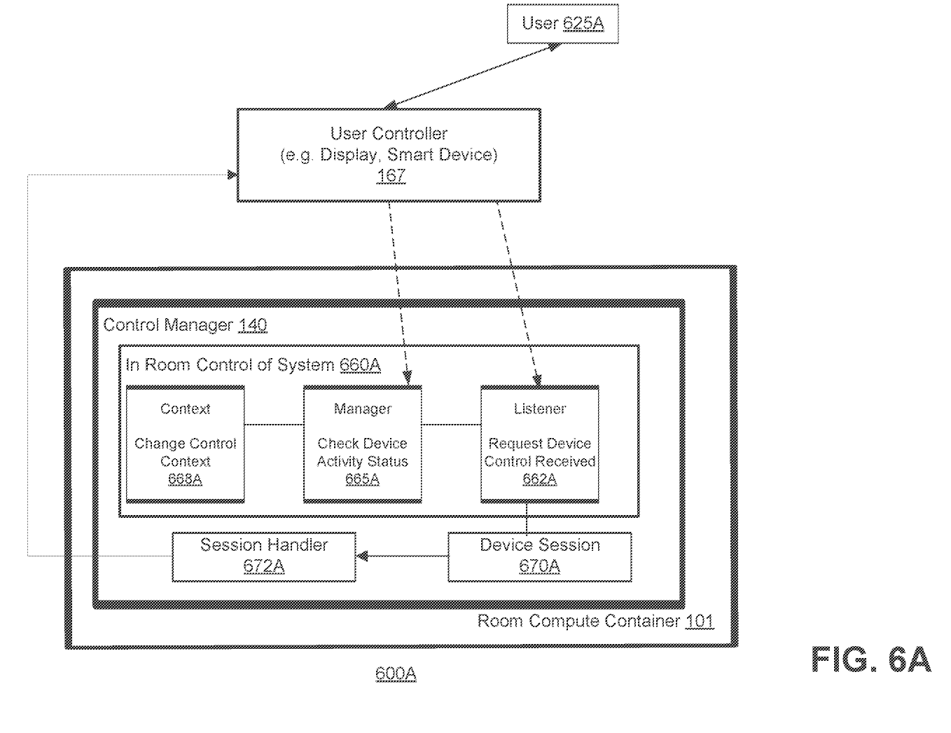

A control device that is active (such as devices 165, 167 and 169) can pass active control seamlessly from one device to another via control switch 160 and control manager 140, subject to any constraints of the space where the controls apply. For example, in a hospital facility, a patient family member's smart phone may be able to control a display monitor in that person's assigned patient room but not in a waiting room. Conversely, content and visual information provided by system 100 may be displayed on a display monitor 169 in a patient room, and may also be made available to other devices, such as tablets and smart phones, and may also include Bring Your Own Devices (such as patients or patient's family members using their personal smart phones or tablet devices). Display monitor 169 may also be implemented directly as an active control device (e.g., as a touch screen), and may also support virtual desktop experiences. In addition to control devices, various sensors and cameras in the room, such as environmental sensor 105, biometric sensor 110, primary sensor 125 and camera array 130 via network endpoint 150 in room compute container 101, may interact with system 100 and via network 180 to integrate, for example, with the facilities system services that control in-room environment (e.g. shades, lights). In some embodiments of the present invention, system 100 also provides seamless context switching of devices, e.g. switching a room camera from fall monitoring to consult mode and back, and will be described later in context with FIGS. 6 and 6A.

FIG. 1A shows an implementation of a converged service appliance (CSA) 150A used in some embodiments of the present invention. Converged service appliance 150A may comprise a physical server or plurality of servers in a data center or other computing facility implemented as part of a cloud computing environment. Converged service appliance 150A may comprise unallocated physical compute resources 165A, comprising storage 106A, memory 103A, and processing 102A resources. Appliance 150A includes allocated compute resources 190A, including one or more instances of room compute containers 101, comprising control manager 140. Allocated compute resources 190A further includes application compute container 186A, which includes applications and system software 188A included with platform 100, such as service bus 460, RFID/RTLS 452, Profiles and Preferences (PnP) 212, and administration module 220. Room compute containers 101 are connected to various physical areas 150A within the facility where CSA 150A is deployed via network 180, where each physical area 150A may include a control device 161 (such as device 165, 167 and 169) and one or more sensors/devices 111 (as shown by environmental 105, biometric 110, and primary 125 sensors, camera array 130, and lighting 115 and temperature 120 controls, as discussed above in the context of FIG. 1.

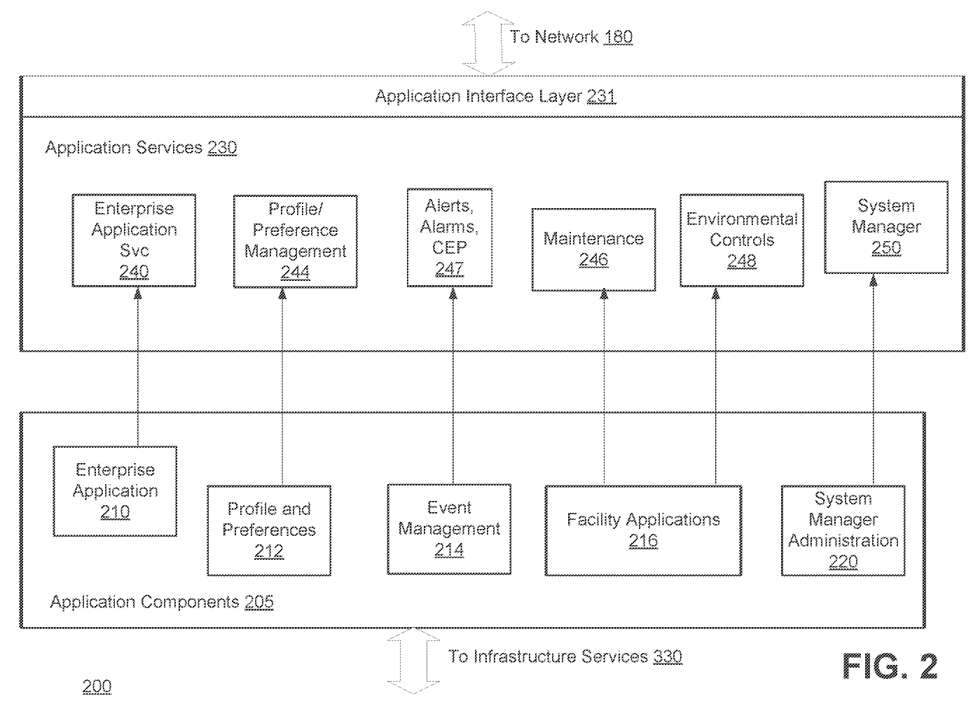

As shown in FIG. 2, in some embodiments of the present invention, the converged service platform via system 100 is connected to the Internet and facility intranet via control manager 140 and network 180, and will aggregate and consolidate existing application services in application layer 200, whether on premises or cloud based. Application interface layer 231 may comprise a collection of APIs such that an integrated user experience can be brought to the display and control that is assigned to specific areas within the facility. Application components 205 can be leveraged to develop and integrate user experiences customized to a particular environment within a facility. In an embodiment of the invention, application services 230 include profile and preference management 244 and system manager 250, which are connected respectively to profile and preference application component 212 and system manager administration application component 220. Application services 230 may, in some embodiments of the present invention, also include event management services such as alerts, alarms and complex event processing (CEP) 247 that may service event management application 214, and specific application services such as enterprise application services 240 which may service enterprise application 210, and maintenance 246 and environmental controls 248, which may service facility applications 216. Any combination of applications that provide their services through APIs can be incorporated into the content that is provided a user in a physical space or room via display monitor 169, for example, and controlled via one of the space or room's active control device options 165, 167 and 169. For example, in a patient room in a health care facility, an important application is fall detection. Fall detection can be implemented through event management application 214 by incorporating alerts, alarms and complex event planning services 247 by looking at time of day, time of last movement, and either turn on the lights if a movement is detected for a user standing up, or alert the nurses' station if a sudden downward movement is detected that may be a fall. Settings for the applications can be displayed on a display monitor and controlled through the various control devices.

Application services 230 also provide a profiles and preferences management service 244 and application 212 to collect, store and edit profiles and preferences that can be used to drive sensors and controls within a facility area. Preferences include explicit and implicit settings such as desired lighting and temperature settings, and other user-specific settings, such as favorite TV channels and genres, and display settings for the area/room's display monitor. Profiles and preferences management service 244 is used in some embodiments of the invention deployed in health care facilities to drive a more personalized room experience for the patient.

Application services 230 also includes a system manager administration service 250 that is used to define areas, is used to allocate resources to an area, is used to manage addition/deletion of devices to the area and define connections between devices, sensors and applications/services, as well as managing device control. Systems manager 250 also configures virtual spaces among available computing resources that correspond to the physical facility, room or area and allocate compute, memory, storage and network resources to each of these physical spaces. System manager administration application 220 also performs systems manager administration roles as well, providing the appropriate levels of security for associating new devices with room compute container 101, and at the user level for accessing applications. Application services 230 can be combined into facility-specific systems of engagement or displayed in their “native” form via application components 205 for communication with the enterprise infrastructure services layer 300.

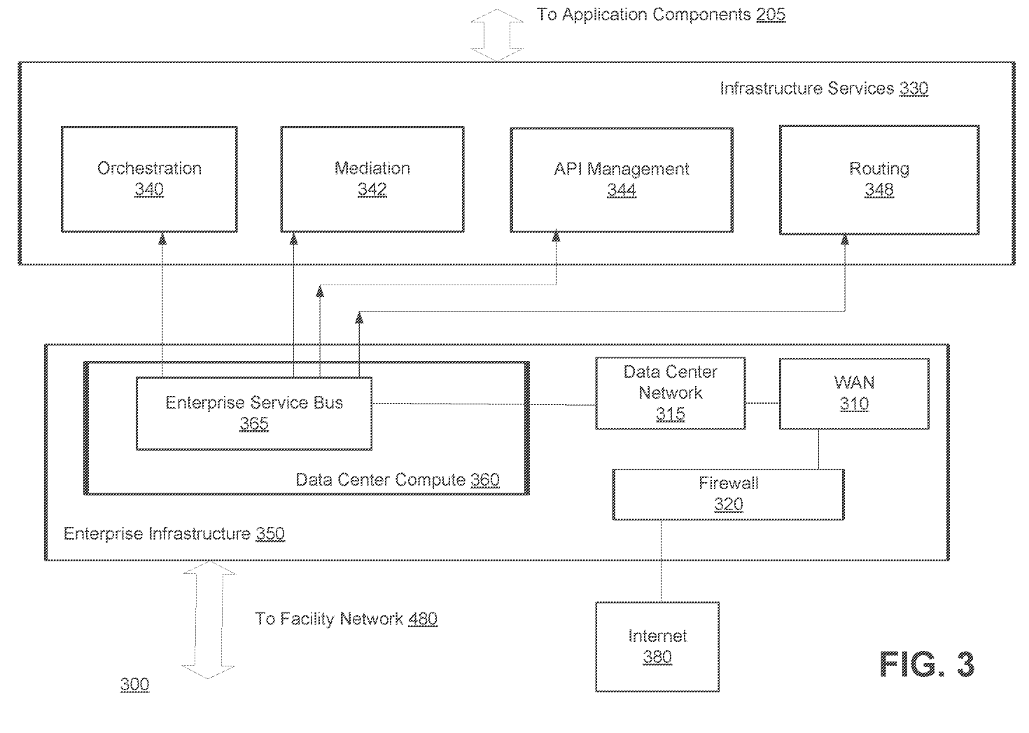

CSA 150A therefore provides an engineered solution for the facility that contains the system software and compute resources necessary to power the facility which can be implemented in a physical appliance as shown by converged service appliance 150A. The facility infrastructure can alternatively, or additionally, be deployed using cloud, virtual, or other on premise infrastructure or hybrid cloud option. Hybrid cloud is defined as the secure consumption of services from sources outside of the application including traditional enterprise applications and other cloud solutions, and may include private on-premise cloud services, private external cloud services and public cloud resources. The solution can, additionally take advantage of any cloud services that are made available to room compute container 101. As a cloud-based solution in some embodiments of the invention, room compute container 101 is configured to be extensible and modular so that it can be enhanced in the future as needed. New services, devices and area specific capabilities can be added without affecting existing features or requiring changes to system architecture. The modular nature of the infrastructure solution will allow it to scale to meet new demand and provide effective enterprise infrastructure services as shown in FIG. 3.

FIG. 3 illustrates an exemplary enterprise infrastructure layer 300 according to an embodiment of the present invention. For example, orchestration 340 is a critical service provided by the enterprise infrastructure services layer 330. For example, when a room sensor detects changes to the temperature or lighting in a room or area, that is communicated environmental controls application service 248 and facilities applications 216 which can then compare with the patient's preference from the profile and preferences application 212 and profile/preference management application service 244. If the room temperature or lighting need adjustment, commands are sent back to the patient's/user's room so that the room controllers make the appropriate adjustments. Mediation services 342 are provided as part of enterprise infrastructure services 330 that help with integration between applications, and maps and transforms message formats. API Management services 344 as a part of enterprise infrastructure services 330 manages the publishing, documenting and monitoring of APIs in a secure, stable environment. Routing services 348 as part of enterprise infrastructure services 330 handles dissemination of messages and commands to the appropriate applications and application instances.

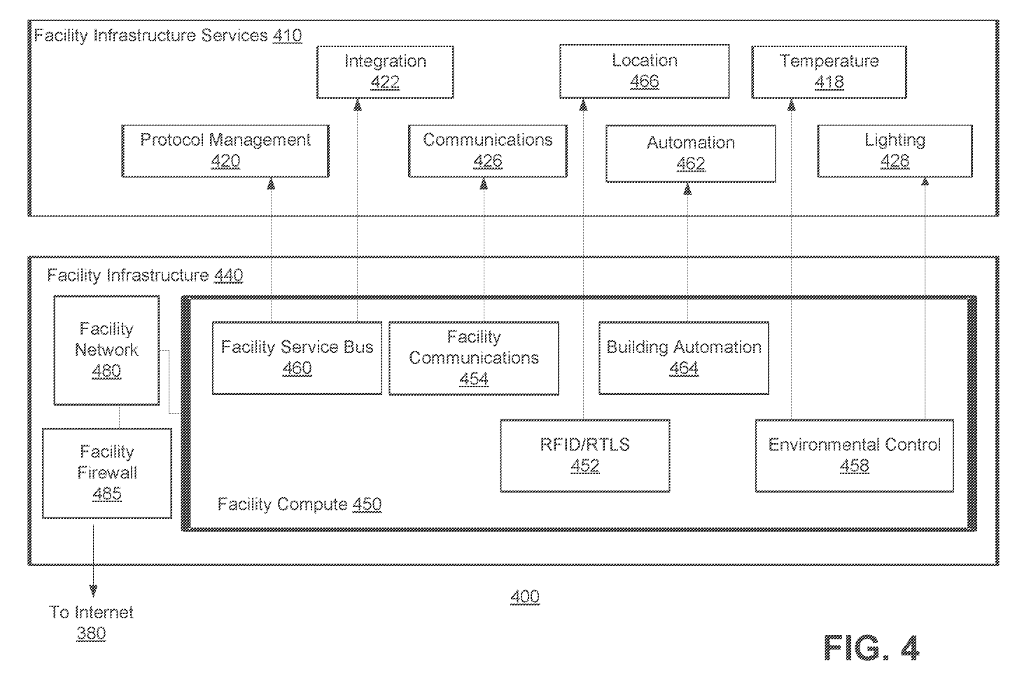

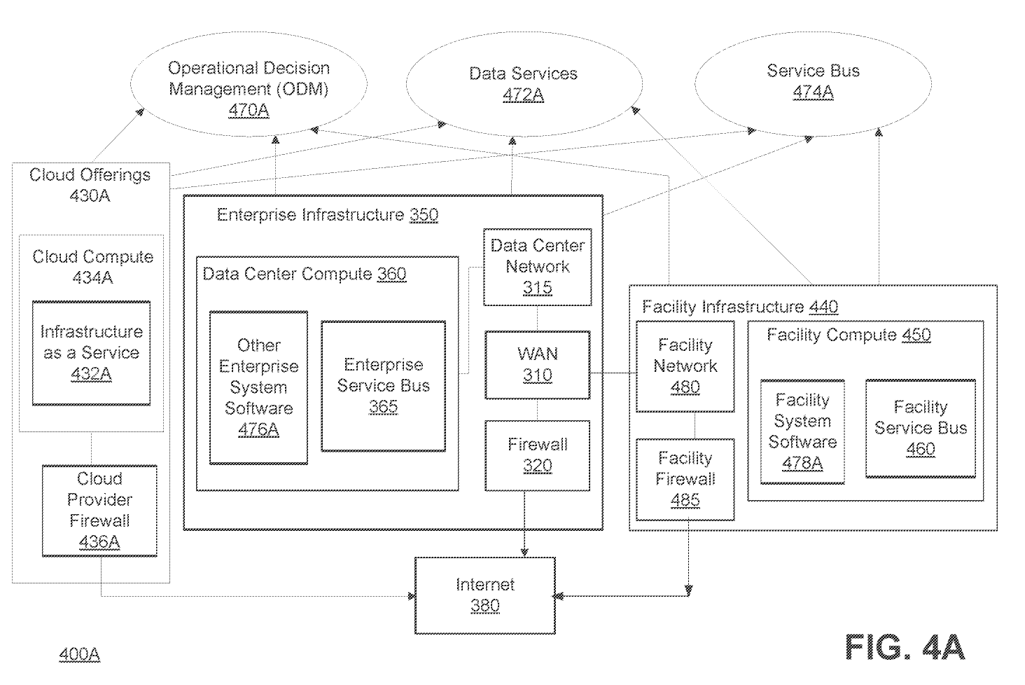

In some embodiments of the present invention, room compute container 101 can access a large variety of services in the facility in which room compute container 101 resides. Such services may be responsible for gathering room information and controlling devices within the room and capabilities (e.g. temperature and lighting) of the room itself. Enterprise service bus 365 in enterprise infrastructure layer 350, and is communicatively coupled to orchestration service 340, mediation service 342, API management service 344, and routing service 348. Service bus 365 may be deployed locally to a facility, or at centralized location as part of an enterprise, or even deployed through cloud services. Service bus 365 may be implemented in data center compute resource 360 in enterprise infrastructure layer 350 and enables linking of the enterprise infrastructure layer 350 and the facility infrastructure layer 400 in FIG. 4 so that all enterprise resources can be accessed and shared with devices and applications within the facility infrastructure layer 440 via data center network 315, WAN 310 and the facility network 480. WAN 310 may also be connected in some embodiments of the present invention to the Internet 380 via firewall 320. Protocol management services 420 are provided in some embodiments of the present invention that enable messaging between different devices using different communications protocols.

The enterprise infrastructure services layer 330 and the facility infrastructure services layer 410 can share communications and service requests. While the enterprise service bus 365 provides mediation of messages between applications, the facility service bus 460 provides protocol management between different devices. Note that in FIGS. 3 and 4, service bus 365 and facility service bus 460 are represented here logically to show that they have separate and distinct functions within enterprise layer 300 and facilities layer 400. However, service bus 365 and facility service bus 460 may be implemented separately or together as a single communications bus to facilitate integration between enterprise-based applications and facilities-based applications and services. Potential use cases for this integration in some embodiments of the present invention include integration of an employee's activities and movements within a manufacturing environment to timekeeping applications. In a clinical health care environment, an exemplary use case could include capturing information gathered from a fall detection solution and incorporating that information into the medical record. Location awareness through real-time location sensing (RTLS) may also be deployed in applications accessible by converged service appliance 150A, locally to a facility, as part of an enterprise, or through public, private or hybrid cloud services. Applications accessible by converged service appliance 150A in some embodiments of the present invention may also support deployment of a real-time data services and analytics environment in the facility and enterprise infrastructures that includes database management, visualization, reporting and analytic tools. The enterprise layer may include, in some embodiments of the present invention, technologies such as data warehouse appliances, massively parallel programming (MPP), and in-memory analytics which may be used to achieve real-time analytics.

Embodiments of the present invention support three major business functions: Facilities Operations, Enterprise Operations, and User Experience. From the standpoint of facilities operations, converged service appliance 150A provides a packaged solution to support multiple control devices and interfaces as experienced by a user, the integration of sensors and devices with application and user interfaces to promote the concept of the “Smart Facility” and integration with various environmental controls. Additionally, location capabilities such as RTLS provide for the movement of devices from space to space within a facility and the modification of device behavior based on the current location of a device.

From an Enterprise Operations perspective, converged service appliance 150A enables access to infrastructure that can optionally be used to host enterprise applications (in particular, for the case where a local installation is required) as well as the integration capabilities to connect facilities operations, user interfaces, and enterprise solutions together into more holistic user experiences.

The user's experience can be tailored and customized via the capture of profile and preference information as enabled by converged service appliance 150A and by tracking the user's location and proximity to different areas within the facility. In addition to bringing a personalized experience of enterprise applications to the user, the platform supports features such as streaming television and video and real-time video and audio communications capabilities within or even outside a facility.

As discussed above, several types of actors can interact with room compute container 101 in some embodiments of the present invention. Generally, each room or area may have an occupant, an individual who interacts with room compute container 101. There may also be collaborators who appear in the room or area who work with the primary occupant and may share control of the system. Additionally, visitors to the room or area may view information displayed to them and experience the environment controlled by the platform, but may not need or receive actual active control of the system, nor have any of their user profiles and preferences captured for uses by the system.

For some embodiments of the present invention used in an office environment, the occupant may be the person assigned an office space which is the room or area of room compute container 101 and who interacts with room compute container 101. Collaborators in an office environment can include various managers and co-workers of the occupant, and visitors may include clients of the office environment. In a clinical environment, the occupant may be a patient checked into a room. Collaborators of the primary occupant in a clinical environment may include various health care providers such as physicians, nurse, and hospital staff charged with the care and upkeep of the facility including housekeeping and facilities maintenance. Visitors in a clinical environment may include the patient's family and friends.

The physical facility where some embodiments of the present invention may be applied is divided up into areas or rooms that contain the display and controls of room compute container 101 and are associated with one or more actors (occupants, collaborators, visitors). At the physical level the area can include devices such as biometric and environmental sensors, cameras, environmental controls for temperature and lighting, as well as RFID and location sensors. As devices are identified that can interact as part of room compute container 101 and become identified with room compute container 101 and the associated physical area, the devices will expose interfaces and/or connect with interfaces to connect with the backplane 150 of the room compute container 101 assigned to the area. Compute resources, such as memory 103 and processor 102 found in room compute container 101 of room compute container 101, can be mapped to a logical area within the platform management capabilities of room compute container 101 and subsequently compute resources may be allocated to specific functions and/or devices.

One aspect of the solution platform is some embodiments of the present invention is the controls layer, shown as 160, 165, 167 and 169 in FIG. 1. As shown in FIG. 1, several devices may assume active control of the room compute container 101, including the primary control 167, a display monitor 169 with touch screen capabilities, or the user's own smart devices 165 such as a tablet. All devices are connected to a control switch 160 which is in turn connected to control manager 140. Control manager 140 allows communication between the controller devices 165 or 167, the monitor 169, and the allocated compute resources in room compute container 101. Additionally, the control switch 160 and control manager 140 provides capabilities for new controllers to be connected to the control manager 140.

Control switch 160 provides the switching service that allows for different controls to become the “master” or designated control. Control switching can be active or passive. Active switching may include activities such as passing or taking control from a user's controller to another person within the room or area with whom the user is collaborating. Passive switching occurs when a new control device becomes active and the current control device has been inactive for a period of time. This period of time may be significant, such as one hour or longer, or may be configurable. Control switch 160 is connected to control manager 140 and ensures that only one device at any time can control the system resources. Resources include the monitor, compute, storage, memory and network allocated to the defined in-facility area and application controls. Control switch 140 also manages where application and facility service outputs are directed, whether to the area's main monitor or to a secondary monitor, tablet or another smart device.

Display monitor 169 can be a standard video monitor with standard input devices such as a keyboard and/or mouse, or it may be a monitor with a touch screen or other touch controls. Control switching of video streaming to different devices, e.g. the in-area display monitor or to a tablet device in the area connected to control switch 160 is also handled through control manager 140. The platform can also register remote endpoints as well as local endpoints found within the facility. This allows for the support of “Extended Enterprise”, e.g. remote locations that can be allocated compute resources and can access and integrate with facility and enterprise applications. In a clinical setting, an example of this extended enterprise may include the clinician at a health care facility and a patient at her home interacting at the patient's home via two tablet devices.

Within the physical room or area, in some embodiments of the present invention connectivity is provided to one or more monitors, the facility network, room or area specific control devices and sensors, monitoring devices and environmental controls. Devices within the defined room connect to an endpoint or backplane 150 that provides for Wireless Personal Area Network Connectivity (WPAN), LAN/WAN, cellular connectivity, and video connectivity. WPAN connectivity allows sensors and other devices, potentially including low power devices, to connect via common protocols such as Bluetooth, Zigbee, Z-Wave, MQTT and others. Both wired and wireless connectivity are supported in embodiments of the present invention. Monitor or video connectivity includes HDMI, DVI and VGA/SVGA connections to support current monitors on the market. Incorporation of additional monitors, LAN/WAN network and WPAN connection types is also contemplated in some embodiments of the present invention. The endpoint provides for connectivity to the facility network via Wi-Fi and/or wired Ethernet connectivity. External Internet connectivity is also accessed through the TCP/IP network connection. Thus, the connectivity to the network includes either or both wired and wireless connections. Cellular network connectivity is also included in the scope of the endpoint solution.

The endpoint 150 provides a local connection for connected sensors and devices identified with a room or area within a facility. The endpoint may make use of multiple communication protocols (e.g. Bluetooth, Wi-Fi) and may support wired or wireless communications. The endpoint will provide modules to support receiver capabilities for the various communication protocols used in different applications. In some embodiments of the present invention, these capabilities are implemented via an appliance type of device, use of a smart monitor, integration of cards into a standard computer (laptop or desktop), or as simple wired ports located in the room or area itself, subsequently connected to a virtual network segment and virtual compute resources. Endpoint 150 may communicate wirelessly or via wired connection with an active controller, for example, such as an primary control 167, smart device 165, display monitor and touchscreen 169 or any of several other control devices.

Endpoint 150 provides the network connectivity for all devices, passive or active, that are associated with that particular area. Location of endpoint 150 may be physically within each area or room in some embodiments of the present invention. Alternatively, the endpoint 150 may be physically located to service several physical areas at once. Mapping of the physical area or room to the area or room's available resources is managed via the system administration module 220 included in and system manager 250 included in the application layer 200. Endpoint 150 is accessed via hardwired network cabling, Wi-Fi, or Bluetooth. The endpoint 150 is in turn connected to the facility network 480, the enterprise intranet (WAN) 310, and ultimately the Internet 380. Proprietary communications links can also be added to the endpoint 150. Communications between devices on different protocols is facilitated via a protocol management service as described below and in FIG. 4. In some embodiments of the present invention, endpoint 150 also communicates messages to sensor devices and controls identified within a specific area. These messages include directives to change a setting on a controlled environmental device (e.g., raise/lower temperature, lighten/dim lighting). Orchestration services 340 provided by infrastructure services 330 on the service bus 365 may send messages through the backplane or endpoint 150 such as switching from a day time camera to a night camera used for fall detection.

In some embodiments of the present invention, it is desired to provide a cost effective, scalable way to provide compute, memory, storage, networking and other data processing resources. Conventional approaches to providing compute and other data processing resources to a room or area revolve around the installation of PCs or other form of workstation or embedded resources within a thin or thick client or other device in the area. In a preferred embodiment of the present invention, cloud architecture technologies may be used to provide compute, memory, storage, networking and other data processing resources.

In a preferred embodiment of the present invention, through the administrative module 220 and system manager 250, a virtual mapping of the entire facility can be created. The facility mapping defines areas or rooms to which resources can be allocated. Once the facility areas or rooms are mapped, the devices, controls and monitors that are local to each of these spaces can be mapped. Subsequently, each of the defined spaces is assigned compute, memory and storage resources appropriate to the activities of that are of the facility. Using cloud-based technologies, these resources can be scaled based on constraints and properties defined for the area or room, to meet changes in demand. Multiple methods of allocation of compute resources are contemplated by some embodiments of the present invention. This delivery of infrastructure could be via an engineered solution as described below, allocation of available enterprise resources, or use private, public, hybrid or managed cloud infrastructure, either on- or off-premises.

In some embodiments of the present invention, within any given area or room of the facility is any number of potential devices that may be connected to and enable to collaborate within the scope of the platform. Some of these devices may be passive in the sense that they connect to infrastructure provided by the platform and take measurements or readings about the area or room within the facility, or individuals within these areas, and pass that information back to other applications or data processing capabilities. An example of such a passive device is a digital temperature gauge that takes readings and passes them to an environmental control application. Other devices are more interactive, receiving messages from an occupant control device or from an application and making changes to the area or room itself. One example of this would be a window shade control that, when a command is sent to it, raises or lowers the shades.

In some embodiments of the present invention, application services 230 and the application components 205 that provide these services can be organized as “Platform” applications—those application components and provided services that include functionality used in the platform. Two applications that are used in a preferred embodiment of the present invention include the system manager administration component 220 and the profile and preferences component 212. “Supported” applications, those which may make use of the infrastructure services 330 provided by the platform or may integrate via use of the service bus 365 and the use of APIs 344. Examples of these supported applications include facilities support applications such as environmental controls 248 or alerts, alarms and complex event processing (CEP) 247.

Systems manager administration component 220 provides capabilities to define virtual spaces and facility locations, and to assign and manage resources associated to the areas or rooms within the facility. Systems manager administration component 220 manages devices and resources to assign resources to spaces within the facility by configuring virtual spaces to assign processor, memory and storage to the virtual space. Systems manager administration component 220 also defines devices and device classes and manages the connection of devices to the facility. In some embodiments of the present invention, the separate areas, rooms and offices within the facility can be modeled logically in the management application. Once defined, each area is assigned compute resources based on defined defaults or based on capacity requirements for that area. In some embodiments of the present invention, a facility may be defined in a GUI-based map that defines areas for system manager administration component 220 to manage shown as logical areas. For example, in a health care facility, logical areas or spaces may be defined as patient rooms, nurse stations, family waiting areas, storage, etc. Definition and creation of logical mappings may be supported by importing floor plans or blueprints of the facility into the systems manager from a facilities application running elsewhere on the platform.

Profile and preferences component 212 promotes a more personalized use of the platform. As discussed above with respect to FIG. 2, the user's profile contains key information such as their name, role, and environmental settings that may be required for the user. For example, in a health care setting, an environmental selection for whether fall detection should be activated may be required for a patient, or in any facility setting, controlling temperature and blinds may be required. In a preferred embodiment, profiles and preferences component 212 is based on a specification that is based upon open standards, such as the European Telecommunications Standards Institute guidelines for user profile management, though an alternative solution that provides a conforming API can be substituted.

FIG. 4 illustrates an exemplary facilities infrastructure layer according to an embodiment of the present invention. In some embodiments of the present invention, Real-Time Location System (RTLS) component 452 is also provided within the facility compute resources 450 of facility infrastructure 440 in facilities layer 400, to manage and track the movement of devices and sensors from place to place within the facility using location services 466, as shown in FIG. 4. RTLS component 452 collaborates with the systems manager administration component 220 and Operational Decision Management (ODM) System service (shown in FIG. 4A) to reallocate the resources to a new location and apply rules to determine whether the device can be included within the scope of the new location. RTLS provides a method to detect the current location of a target device within the scope of the facility in real-time. RTLS component 452 collaborates with the management application and with the elastic demand management of the infrastructure services. RTLS component 452 is capable of tracking devices as they move throughout the facility and are subsequently controlled by different controllers in different systems in different rooms or areas. RTLS component 452 is also capable of tracking individuals as they move throughout the facility to bring their profile and preferences with them to new areas or rooms in order to apply changes, such as environmental systems changes, to their new location within the facility. Capabilities of RTLS in some embodiments of the present invention includes:
Full wireless solution, minimize cable installation
Distance+arrival angle (3° accuracy 2D or 3D)
Automatic deployment (no need for calibration)
2.1 cm accuracy (bias error)
to 30 cm position accuracy (depends on type of anchor and environment)
UWB+motion analysis
Low idle current 95 nA, RTC&RAM=on
0.6 Watt power consumption (anchors)
Wired and wireless synchronization
Continuous signal quality and strength evaluation
AES-256 encryption
Open source tag designs
Update rate 8000 updates/sec/channel
Range >1.1 km, 6.8 Mbps (horn antenna)

In a preferred embodiment, RTLS component 452 is based on Open Standards, although an alternative solution that provides a conforming API can be substituted. In some embodiments of the present invention, the Open RTLS API may be used to implement the detection of the location of target devices within the scope of the facility at http://wiki.openrtls.com. One reference implementation of the Open RTLS API that may be used in some embodiments of the present invention includes Decawave (www.decawave.com).

In some embodiments of the present invention, facility compute 450 may also include system software components for environmental controls (e.g. temperature, humidity) 458, facility service bus 460, building automation 464, and facility communications 454. These components may connect with various facility infrastructure services 410, such as protocol management 420, integration 422, both services for facility service bus component 460, automation 462, communications 426, lighting service 428, and temperature service 418 for environmental control component 458. In some embodiments of the present invention, facility compute 450 may also connect to facility network 480 and to the Internet 380 through facility firewall 485.

The platform supports enterprise applications in a combination of capabilities. In one case, the enterprise infrastructure 350, provided via the engineered solution or via cloud, can be utilized for platform enterprise applications as well as the included system software and any facilities solutions, and may be used for a single facility organization as well as organizations spanning multiple facilities. In addition, the integration capabilities packaged into the platform and development tools included in infrastructure services 330 are delivered with the notion of integrating applications and facilities together via APIs. These user experiences can be displayed on the area's monitor and controlled via the various control devices. Any combination of applications that provide their services through APIs can be incorporated into the content that is provided to the user in the room, office or other area via the display monitor and controlled via one of the control device options. As mentioned and as shown in FIG. 3 the platform has intra and Internet connectivity and can access any service provided whether it is on premises or cloud-based. In addition, application services 230 for example can be combined into facility-specific systems of engagement or displayed in their “native” form.

To support integration of various devices, applications, streaming video and data into a seamless user experience, the platform includes User Interface (UI) tools and frameworks to integrate user interfaces with applications, as shown in Table 0.

TABLE 0

| Tool Purpose | Reference Implementation |
|---|---|
| Language | TypeScript |
| MVC | Angular JS (https://angularjs.org) |
| JavaScript library for HTML document | jQuery (https://jquery.com) |
| traversal and manipulation, event | |
| handling, animation, and AJAX | |
| Framework for Dependency Injection | Spring Framework |
| | (http://projects.spring.io/spring-framework) |
| Framework for Inversion of Control (IOC) | Spring Framework |
| | (http://projects.spring.io/spring-framework) |
| Framework for Aspect-Oriented | Spring Framework |
| Programming (AOP) | (http://projects.spring.io/spring-framework) |
| Framework for RESTful Web Services | Spring Framework |
| | (http://projects.spring.io/spring-framework) |
| Domain Model Persistence, Object | Hibernate (http://hibernate.org) |
| Relational Model (ORM) | |
| Client Side Data Processing | Underscore |
| Responsive Design Framework | Bootstrap |
| Code Quality | TShint |
| | (https://github.com/palantir/tslint) and |
| | JSHint (jshint) |
| Code Coverage | Istanbul |
| | (https://github.com/yahoo/istanbul) |
| Unit Test Framework | Jasmine (http://jasmine.github.io/) |
| Test Runner | Karma (https://karma-runner.githu.io/1.0/index.html) |
| Mock REST API | Canned |
| | (https://github.com/sideshowcoder/canned) |
| Document Generation | Type Doc (http://typedoc.io/) |

Coupled with the included service bus capabilities and its inherent integration capabilities, in some embodiments of the present invention, room compute container 101 can utilize these UI layer tools and frameworks to access applications via APIs and bring data and operations together into a user experience that is tailored to the user with the included personalization capabilities, profiles and preferences.

In some embodiments of the present invention, the technology infrastructure layer provides the compute nodes, networks, system software and infrastructure services required for the platform. The enterprise and facility infrastructure layers are tied together such that all enterprise resources can be accessed and shared with devices and applications within the facility infrastructure. In some embodiments of the present invention, the facility service bus 460 and enterprise service bus 365 can share communications and service requests. While the enterprise service bus provides mediation of messages between applications, the facility service bus 460 provides protocol management between different devices. The enterprise service bus 365 and the facility service bus 460 are shown in separate enterprise and facility service layers 300 and 400 respectively to show a separation of functions. However, they can be implemented separately or all within one bus. Enterprise Infrastructure layer 300 is focused on providing infrastructure and services to support the facility.

In one embodiment of the present invention, enterprise service bus 365 and facility service bus 460 may be implemented as one or more commercial or open standards based enterprise services buses (ESBs). Enterprise service bus 365 integrates enterprise level services such as the electronic medical/health records (EMR) used in health care facilities, long term analytics, and identity and access management services. Reference implementations that may be used in some embodiments of the present invention includes OpenESB (www.open-esb.ent), IBM WebSphere Enterprise Service Bus from IBM Middleware (http://www.ibm.com/middleware/us-en/knowledge/connectivity-and-integration/enterprise-service-bus-esb.html), and Apache Kafka (kafka.apache.org). Enterprise service bus 365 and Facility service bus 460 may be implemented together in one physical implementation, multiple implementations within an enterprise data center, or a combination of two or more bus implementations at multiple physical locations.

Facility service bus 460 provides the following capabilities and system services: routing, protocol management, message mediation, transformation & aggregation, orchestration, integration, API management, service security, message bus, and API endpoint. Facility service bus 460 can be either a logical bus, part of a larger enterprise bus such as enterprise service bus 365, or a localized physical bus specific to a facility. Facility service bus 460 integrates facility level services such as building automation systems which control lighting, blinds and temperature. Real-time location systems and facility-based communications also integrate with facility service bus 460.

It is expected that a large enterprise would have infrastructure and data centers to support its enterprise systems. However, a smaller organization (e.g. single facility) would also be capable of deploying enterprise solutions to the supplied engineered solution. In addition, Facility Infrastructure layer 400 comprise a large variety of facility infrastructure services 410 such as temperature 418, lighting 428, communications 426, integration 422, protocol management 420, and other services that ultimately are responsible for gathering information and controlling devices within the in-facility area and controlling the environment capabilities (e.g. temperature and lighting) of the physical space itself.

FIG. 4A illustrates an exemplary technology infrastructure layer according to an embodiment of the present invention. Compute resources are available in some embodiments of the present invention via cloud, enterprise or facilities infrastructure as discussed above. FIG. 4A shows an exemplary technology infrastructure layer 400A that may be used to implement the enterprise and facility infrastructure layers of FIGS. 3 and 4. Data services 472A are services made available on top of this infrastructure including database, compute, memory, storage, security, authorization and access management and elastic demand management, and may be accessed via facility system software 478A and other enterprise system software 476A. Service bus 474A can include functionality for facility service bus 460 and enterprise service bus 365 to integrate facility level services and enterprise level services.

In some embodiments of the present invention, the platform may be implemented as a collection of services deployed partially or entirely to a cloud services infrastructure in cloud offerings 430A having one or more cloud compute nodes 434A as an Infrastructure as a Service (IaaS) 432A. The cloud services infrastructure may include public, private, managed or hybrid cloud offerings and would include implementation of the appropriate network connectivity, including cloud provider firewall 436A, to support the traffic generated throughout the platform. In some embodiments of the present invention, the OpenStack capabilities may be used to provision images and assign compute, storage and networking resources to the facility as needed. The services are available via the Horizon dashboard or via Open APIs. In some embodiments of the present invention, demand elasticity is also managed by OpenStack capabilities as follows:

TABLE 1
OpenStack Services

| | OpenStack | |
|---|---|---|
| Service | Name | Description |
| Dashboard | Horizon | Provides a web-based self-service portal to interact |
| | | with underlying OpenStack services, such as |
| | | launching an instance, assigning IP addresses and |
| | | configuring access controls. |
| Compute | Nova | Manages the lifecycle of compute instances in an |
| | | OpenStack environment. Responsibilities include |
| | | spawning, scheduling and decommissioning of |
| | | virtual machines on demand. |
| Networking | Neutron | Enables Network-Connectivity-as-a-Service for |
| | | other OpenStack services, such as OpenStack |
| | | Compute. Provides an API for users to define |
| | | networks and the attachments into them. Has a |
| | | pluggable architecture that supports many popular |
| | | networking vendors and technologies. |

Storage

| | | |
|---|---|---|
| Object | Swift | Stores and retrieves arbitrary unstructured data |
| Storage | | objects via a RESTful, HTTP based API. It is |
| | | highly fault tolerant with its data replication and |
| | | scale-out architecture. Its implementation is not |
| | | like a file server with mountable directories. In |
| | | this case, it writes objects and files to multiple |
| | | drives, ensuring the data is replicated across a |
| | | server cluster. |
| Block Storage | Cinder | Provides persistent block storage to running |
| | | instances. Its pluggable driver architecture |
| | | facilitates the creation and management of block |
| | | storage devices. |

Shared Services

| | | |
|---|---|---|
| Identity | Keystone | Provides an authentication and authorization |
| | | service for other OpenStack services. Provides a |
| | | catalog of endpoints for all OpenStack services. |
| Image | Glance | Stores and retrieves virtual machine disk images. |
| | | OpenStack Compute makes use of this during |
| | | instance provisioning. |
| Telemetry | Ceilometer | Monitors and meters the OpenStack cloud for |
| | | billing, benchmarking, scalability, and statistical |
| | | purposes. |

Other, High-Level Services

| | | |
|---|---|---|
| Orchestration | Heat | Orchestrates multiple composite cloud |
| | | applications by using either the native HOT |
| | | template format or the AWS CloudFormation |
| | | template format, through both an OpenStack- |
| | | native REST API and a CloudFormation- |
| | | compatible Query API |

An Operational Decision Management (ODM) module 470A is also included as part of the platform and runs concurrently with the data services and the facility service bus 460 and the enterprise service bus 365. ODM module 470A is supplied as part of the platform to govern the rules surrounding the way various devices connected through room compute container 101 interact with each other and how control is passed between devices and controllers. ODM module 470A comprises a set of technologies that permit automation of business decisions without compromising accuracy and effectiveness of the decisions, and allows the definition, documentation, implementation, change and governance of repeatable decisions made during business operations. A decision as identified by the ODM module is an outcome for a given situation with various included considerations, a given actor, and a combination of rules that get applied to arrive at the decision. In some embodiments of the present invention, ODM processing allows the creation and management of rules that govern how resources and controllers interact within the facility, thus providing business rule processing that adds intelligence to the facility. As an example, if an event is received identifying a patient as a fall risk, then a rule will be output that sets camera priority to fall detection.

In some embodiments of the present invention, ODM module 470A may be implemented using Drools (www.drools.org) business rules management system as a reference implementation. Capabilities include: a user interface for rules editing, and a rules engine (runtime engine) that includes (1) support for an ontology, data and rules, (2) implementation of a rules matching algorithm (e.g. Rete pattern matching algorithm), and (3) a reasoning system (e.g. hybrid, forward-chaining, or backward chaining). Other capabilities include Complex Event Processing and support for a complete lifecycle. In some embodiments of the present invention, a lifecycle could include: (i) Author—authoring of knowledge using BPMN2, decision table, class models; (ii) Build—building the authored knowledge into deployable units; (iii) Test—testing KIE (Knowledge Is Everything) knowledge before it is deployed to the application; (iv) Deploy—deploys the unit to a location where applications may utilize (consume) them; (v) Utilize—the loading and exposing of a container to provide a session, for which the application can interact with; (vi) Run—system interaction with the session, via API; (vii) Work—user interaction with the session, via command line or UI; and (vii) Manage—manage any session or container.

In some embodiments of the present invention, CSA 150A provides localized facilities with cloud platform capabilities to support the facility including the creation of virtual containers that represent rooms or offices and common areas within the facility. In some embodiments of the present invention, CSA 150A may be implemented as a localized hardware appliance containing the network and compute capabilities required for each room. Alternatively, room compute container 101 comprises localized hardware that provides an essential network endpoint 150 and connectivity to monitors and control devices, but moves most networking and compute capabilities to virtual network and cloud compute resources as a part of CSA 150A. Compute and other resources can be allocated in an elastic and scalable manner to each of these containers and to the facility. Elastic resources can be provided to add or remove compute resources to one of the defined virtual rooms, offices or facilities areas within a single facility or across associated multiple facilities. The architecture for converged system appliance 150A may be implemented in different size options appropriate to the size of the facility, and may scale to support increasing network and compute demands. In a preferred embodiment, CSA 150A provides a completely redundant solution with both compute and optional storage server components that may be used to provide analytic capabilities. Technical specifications for an exemplary embodiment of CSA 150A is provided the Table 1 set forth below:

TABLE 2

| Component | Description |
|---|---|
| N + N Power Supplies | Uninterruptible Power Supply is provided through N + N |
| | Power supplies |
| Multiple Redundant Fan | Multiple redundant fans are included to ensure that the |
| Modules with hot-swap | system does not fail due to overheat. Additionally, a failed |
| capability | fan can be swapped without shutting down the system. |
| Processors | 2 to N multi-core processors are implemented with fault- |
| | tolerance. Example processors include Intel Xeon E7- |
| | 8890 (24 cores) or Xeon X5 2699v4 (18 cores) |
| Memory | Multiple DIMMS memory per CPU Socket or as limited |
| | by processor; the patent application also covers the use of |
| | Resistive RAM and other improvements in this area. |
| InfiniBand Adapter | 40 Gb/Second (QDR) InfiniBand |
| Gigabit Ethernet (GbE) | Dual multi-port GbE Adapters provide network |
| Adapter | connectivity |
| Flash Accelerator | Multiple, redundant flash accelerator cards |
| Disk Storage | The base appliance comes equipped with redundant, high |
| | availability disk storage for storage and processing of the |
| | application stack combined with the patient room |
| | computing system. |
| Automatic Data Tiering | Data is automatically tiered between RAM, Flash and |
| | Disk |
| Encryption in firmware | Data encryption is implemented in system firmware |
| Storage Server (optional) | An optional external storage server can be included to |
| | extend storage capacity. |

In another embodiment of the present invention, CSA 150A may be implemented as a completely cloud-based solution deployed to external Platform as a Service (PaaS) solutions. Technical specifications for an application stack that may be installed in some embodiments of the present invention are shown in Table 3 below.

TABLE 3

| Installed | |
|---|---|
| Component | Description |
| System | The Administrative Component provides the capability to |
| Management | define virtual spaces and facilities locations, to allocate |
| | resources to those areas. Configuration of virtual spaces to |
| | assign processor, memory and storage to the virtual space |
| | is managed in this module. |
| | System monitoring, configuration of allocation rules |
| Service Bus | The Facility Service Bus provides the following |
| | capabilities and system services: |
| | Routing |
| | Protocol Management |
| | Message Mediation, Transformation & |
| | Aggregation |
| | Orchestration |
| | Integration |
| | API Management |
| | Service Security |
| | Message Bus |
| | API Endpoint |
| | The Facility Service bus can be either a logical bus, part of |
| | a larger enterprise bus or a localized physical bus specific |
| | to a facility. |
| Cloud | Provides Elastic Resources to add or remove compute |
| Management | resources, memory or storage to one of the defined virtual |
| | rooms, offices or facilities areas |
| Security | Security manages the authorizations and authentications of |
| | devices and their attachment to the facility. Security works |
| | in conjunction with an Enterprise supplied, LDAP based |
| | authentication and authorization tool for managing users of |
| | the system. Standalone the solution supplies its own |
| | LDAP based solution |
| Profile and | Profile and Preference is used to drive a more personalized |
| Preference | experience for the user. Profile and Preference is an |
| | included part of the platform although an alternative |
| | solution that provides a conforming API can be substituted. |
| | The provided solution is based on Open Standards. |
| Application | Based on Open Container Initiative (OCI) containers wrap |
| Containers | a piece of software in a complete filesystem that contains |
| | everything needed to run: code, runtime, system tools, |
| | system libraries - anything that can be installed on a |
| | server. It is designed to be lightweight: Containers running |
| | on a single machine share the same operating system |
| | kernel; they start instantly and use less RAM. Images are |
| | constructed from layered filesystems and share common |
| | files, making disk usage and image downloads much more |
| | efficient. |
| | Containers are based on open standards, enabling |
| | containers to run on all major Linux distributions and on |
| | Microsoft Windows -- and on top of any infrastructure. |
| | Containers isolate applications from one another and the |
| | underlying infrastructure, while providing an added layer |
| | of protection for the application. |
| | It is expected that the solution will use Docker or a similar |
| | implementation of OCI. |
| OpenStack | OpenStack is an open-source cloud computing platform for |
| | creation and management of large pools of compute, |
| | storage, and networking resources in public and private |
| | clouds |
| | With OpenStack administrators can: |
| | Upload and manage images |
| | Configure access and security for instances |
| | Launch and manage instances |
| | Create and manage networks |
| | Create and manage object containers |
| | Create and manage volumes |
| | Create and manage shares |
| | Launch and manage stacks |
| | Create and manage databases |
| | Create, View and manage load balancers |
| | OpenStack uses a modular architecture to provide a set of |
| | core services that facilitates scalability and elasticity as |
| | core design tenets. |
| | OpenStack Compute service (nova) provides services to |
| | support the management of virtual machine instances at |
| | scale, instances that host multi-tiered applications, dev/test |
| | environments, “Big Data” crunching Hadoop clusters, |
| | and/or high performance computing. |
| | The Compute service facilitates this management through |
| | an abstraction layer that interfaces with supported |
| | hypervisors. |
| | Supported Hypervisors include: MS Hyper-V, Ironic, |
| | Libvirt KVM (ppc64), Libvirt KVM (s390x), Libvirt KVM |
| | (x86), Libvirt LXC, Libvirt QEMU (x86), Libvirt |
| | Virtuozzo CT, Libvirt Virtuozzo VM, Libvirt Xen, |
| | VMware vCenter, XenServer |
| RTLS | Based on OpenRTLS, RTLS provides the application |
| (Optional) | technology to detect the current location of a target device |
| | within the scope of the facility. |
| | An alternative RTLS solution, already in use at the facility, |
| | the exposes necessary APIs can be substituted for the |
| | included RTLS solution. |
| API | Installed on the Service bus, API Management provides |
| Management | publishing, documentation, monitoring and transformation |
| | of Application Programming Interfaces |

The systems manager administration component 220 works with the OpenStack APIs (Compute, Block Storage, Networking, Image Service, Object Store and Security) to allow the mapping of virtual facility areas to the data services (computer, storage, memory, networking) that are required to support that area.

The platform also includes an Open LDAP (Lightweight Directory Access Protocol) implementation. Alternatively, the solution can integrate with any LDAP solution that provides the same LDAP API and LDAP Protocol Operations (see Table 4 below).

TABLE 4
LDAP Interface Operations.

| | |
|---|---|
| StartTLS | use the LDAPv3 Transport Layer Security (TLS) |
| | extension for a secure connection |
| Bind | authenticate and specify LDAP protocol version |
| Search | search for and/or retrieve directory entries |
| Compare | test if a named entry contains a given attribute value |
| Add | Add a new entry |
| Delete | Delete an entry |
| Modify | Modify an entry |
| Modify | move or rename an entry |
| Distinguished Name | |
| (DN) | |
| Abandon | abort a previous request |
| | Extended Operation - generic operation used to |
| | define other operations |
| Unbind | close the connection (not the inverse of Bind) |

For profiles and preferences component 212, the API used in some embodiments of the present invention is a REST API. Resources in JSON format are created and updated through the API using HTTP POST calls, and deletes are made using an HTTP delete to the resource URL. The API supports, minimally, operations for a user account and profile data associated with a user. In other embodiments of the present invention, implementations of profiles and preferences component 212 provide additional operations for applications, groups, organizations, membership and store information.

TABLE 5
Basic Operations of the Profiles and Preferences API

| Description | Operation | Attributes |
|---|---|---|
| Create a new | POST /csa/$FACILITY/useraccounts | Required: |
| UserAccount | | lastName, |
| resource | | firstName, |
| | | username, |
| | | email, |
| | | password |
| | | Optional: |
| | | middleName, |
| | | profileData |
| Modify a | POST | lastName, |
| user account | /csa/$FACILITY/useraccounts/ | firstName, |
| | $USERACCOUNT | username, |
| | | email, |
| | | password |
| | | Optional: |
| | | middleName, |
| | | profileData |
| Retrieve | GET | |
| User Profile | /csa/$FACILITY/useraccounts/ | |
| Data | $USERACCOUNT | |
| Delete a | DELETE | |
| User | /csa/$FACILITY/useraccounts/ | |
| Account | $USERACCOUNT | |
| Create a new | POST /csa/$FACILITY/profileData | profileData name |
| profileData | | profileData |
| resource | | Description |
| Modify a | POST /csa/$FACILITY/profileData | Resource value |
| profileData | /$PROFILEDATAID | |
| resource | | |
| Retrieve | GET | |
| User Profile | /csa/$FACILITY/profileData | |
| Data | /$PROFILEDATAID | |
| Delete a | DELETE | |
| User | /csa/$FACILITY/profileData | |
| Account | /$PROFILEDATAID | |

Each defined area within the facility requires sufficient compute to run “network” applications, process streaming video and run the local device manager. To simplify assignment of resources, in some embodiments of the present invention, the definition of defaults is enabled. Alternatively, more or less resources can be explicitly defined as well. Once the defaults and customized resource assignments have been defined, they can be mapped to the mapped areas within the facility, as shown in the diagram of the first floor of a building below where rooms have the “Default” resource assignment, and the Nurse Station 1A has a customized resource assignment:

| | |
|---|---|
| Resource | Setting |

Assignment: Default

| | |
|---|---|
| Compute | 4 cores, 64 bit |
| Memory | 8 GB |
| Storage | 64 GB |
| Upward Threshold | 70% |
| Lower Threshold | 10% |

Assignment: Nurse Station 1A

| | |
|---|---|
| Compute | 8 cores, 64 bit |
| Memory | 32 GB |
| Storage | 512 GB |
| Upward | 70% |
| Threshold | |
| Lower | 10% |
| Threshold | |

The platform integrates with existing Identity and Access Management (IAM) solutions through LDAP or exposed APIs in some embodiments of the present invention. Device authorization may be managed at a fine grain, such as through pre-shared device keys or public key infrastructure (PKI) for security. Differentiated access control is managed by the system manager administration component 220. When a new device is added to the room compute container 101 in makes an access request for the system manager administration component 220. Component 220 evaluates the request and either issues an authorization assertion or denies the request. Assertions are based on standards (XACML, SAML).

Some embodiments of the present invention utilize an asset registry. The term asset includes room compute container 101, as well as various devices and servers provisioned throughout a facility. An asset registry includes storage which contains discovery and reference data associated with the provisioned assets, and thus stores metadata of the provisioned assets. At the conceptual level, the asset registry will have the following functions supported in it:
Register Asset: to register the asset in the context of a smart facility;
Unregister Asset: to remove the asset in the context of a smart facility;
Activate Asset: to activate the asset from a previously deactivated state; and
Update Asset Metadata: to update/manage the asset metadata in the registry.

In some embodiments of the present invention, an asset can be discovered inside a smart facility by any of the following techniques:
Look-up of the asset description based on the asset identifier;
Discovery of the asset description based on the asset specifications;
Resolution of the asset identifier based on the asset locator; and
Import assets for asset management.

The asset registry in some embodiments of the present invention can be implemented in any of a variety of types of databases or asset management systems known in the art, such as a relational database, where information about each asset can be stored as a record in the database. For assets have complex metadata that may be cumbersome to implement in a relational database record, the asset registry can be made extensible by storing the asset metadata information in XML (eXtensible Markup Language) or JSON (JavaScript Object Notation) format. Alternatively, asset information can be stored in a NoSQL (non-relational) database, for example in a document format where each document will represent one asset. A NoSQL database can be well suited as a storage mechanism for assets used in the platform as sometimes the metadata of the asset can be complex in nature and can differ for different types of servers and devices. Other types of NoSQL databases such as key value or column may also be used for the asset registry. In other embodiments of the present invention, an in-house registry can be created, or existing asset management systems can be extended to store asset-related information pertaining to a facility.

In some embodiments of the present invention, room compute container 101 may contain a device registry to store the discovery and reference data related to the provisioned devices. The device registry may store the metadata of the provision devices and will support the following function types:
Register Device to register the device in the context of a smart facility, room or area;
Unregister Device to remove the device in the context of a smart facility, room or area;
Activate Device to activate the device from a previously deactivated state;
Deactivate Device to deactivate the device from the previously activated state; and
Update Device Metadata to update/manage the device metadata in the registry.

Furthermore, in some embodiments of the present invention, a device can be discovered inside a smart facility or building by any of the following techniques:
Look-up of the device description based on a device identifier;
Discovery of the device description based on the device specifications; and
Resolution of the device identifier based on a device locator.

Like the asset registry, the device registry in some embodiments of the present invention can be implemented in any of a variety of types of databases or asset management systems known in the art, such as a relational database, where information about each device can be stored as a record in the database. For devices have complex metadata that may be cumbersome to implement in a relational database record, the device registry can be made extensible by storing the device metadata information in XML (eXtensible Markup Language) or JSON (JavaScript Object Notation) format. Alternatively, device information can be stored in a NoSQL (non-relational) database, for example in a document format where each document will represent one device. A NoSQL database can be well suited as a storage mechanism for devices used in the platform as sometimes the metadata of the asset can be complex in nature and can differ for different types of servers and devices. Other types of NoSQL databases such as key value or column may also be used for the asset registry. In other embodiments of the present invention, an in-house registry can be created, or existing asset management systems can be extended to store device-related information pertaining to a facility, room or area.

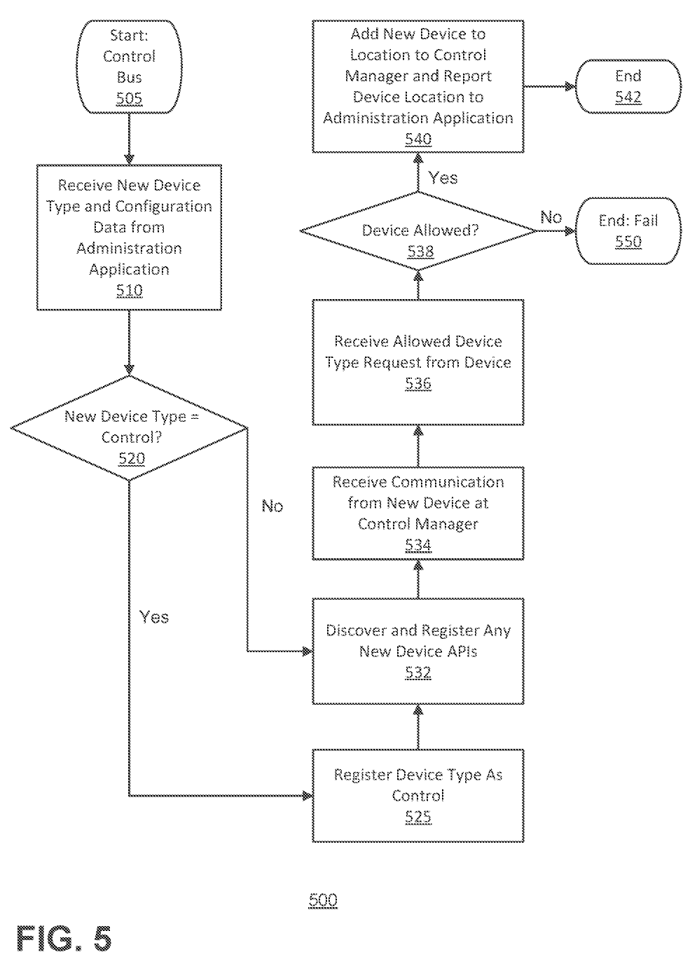

FIG. 5 is a flow diagram showing a process 500 to add new devices and sensors into a scope of control of room compute container 101 in some embodiments of the present invention. As shown in FIG. 5, the capability of defining and controlling acceptable device types for some embodiments of the present invention is managed through the systems manager/device administration component 220. A human or other actor assuming a system administrator role can communicate via a device such as smart device 165, or display monitor 169 through control manager 140 starting at 505. At 510, the system manager administration component 220 receives new device type and configuration data information entered by the administrator. At 520, the administration component 220 communicates with the control manager 140, and if the device is a control device, registers the device type as control at 525. At 532, system manager administration component 220 also runs discovery on the new device to determine any available APIs for the new device and registers those with the enterprise service bus 365 to allow for the application of enterprise policy to which APIs will be allowed within the environment. When a new sensor or device is introduced within a room or area at 534, it communicates with control manager 140. At 536, the sensor asks for a connection from the network endpoint 150, and the backplane makes a request to the control manager to determine if the device is an allowed type as shown at 538. If the device is a known type, it is added to the network endpoint, and the device location is reported to the system manager administration component 220 at 540 before the process ends at 542, otherwise the process fails at 550.

FIG. 6 is a flow diagram showing a process 600 for context switching to a new device in a room or area for some embodiments of the present invention. A system diagram showing the controller and other components that may be used to perform the exemplary process 600 is shown in FIG. 6A. At 605, a device controller connected to control manager 140 is running within room compute container 101. At 610, the controller 660A in FIG. 6A maintains a device context 668A, a device manager 665A, and a listener 662A. At 615, controller 660A assigns a listener to the device manager. At 620, an actor 625A in the room or area may initiate a request to the device manager 665A through controller 161. At 625, the device manager 665A sends a device object corresponding to the new device request, and the device context object to the listener 662A. At 630, the listener now knows to listen for messages from this device and initiates a device session 670A and session handler 672A specific to that device. At 635, the session handler 672A receives and forwards messages from and to the new device. At 640, a message from the device may be a close request, in which case the device session and session handler are closed at 650.

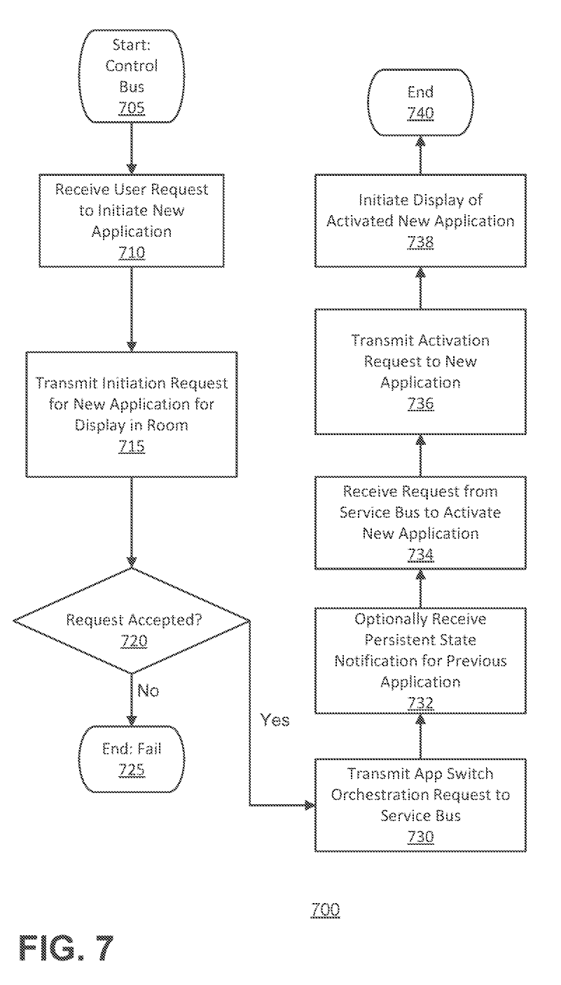

FIG. 7 is a flowchart of an embodiment of a method of application switching of the present invention. In some embodiments of the present invention, the platform manages integration of devices, monitors and sensors, and incorporates interaction with the facility service bus 460 that controls facilities operations devices. Additionally, through the interaction of room compute container 101 and the enterprise service bus 365, switching between applications may be mediated, as shown in the flow diagram 700 of FIG. 7. At 705, a request is initiated via an actor (such as a clinician) sending a request from an application component (such as a video conference application. At 710, this request is mediated by the control manager 140 which determines that the clinician user is actively using the system. At 715, the control manager 140 transmits and initiation request to the display monitor 169 in the room, which displays a notification (e.g., a request for a video conference) in the room or area which may be accepted or rejected by an actor (e.g., a patient) in the room at 720. Of course, if the patient rejects the video conference request the process ends at 725. If the request is accepted at 720, an application switch orchestration request is sent at 730 to the enterprise service bus 365. At 732, the control manager 140 may optionally receive a persistent state notification for the previously running application (e.g., by pausing a movie playing on the display monitor). The control manager will then receive a request from the enterprise service bus 365 to activate the new application (e.g., telemedicine video conference) at 734. At 736, control manager 140 will transmit the request to the new application which will then initiate display of the activated new application at 738, which concludes the process at 740.

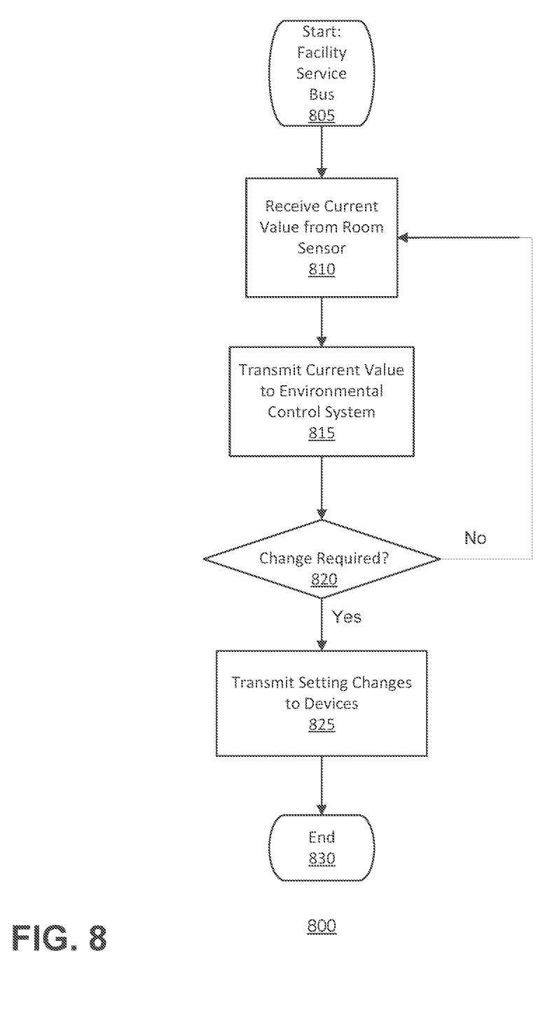

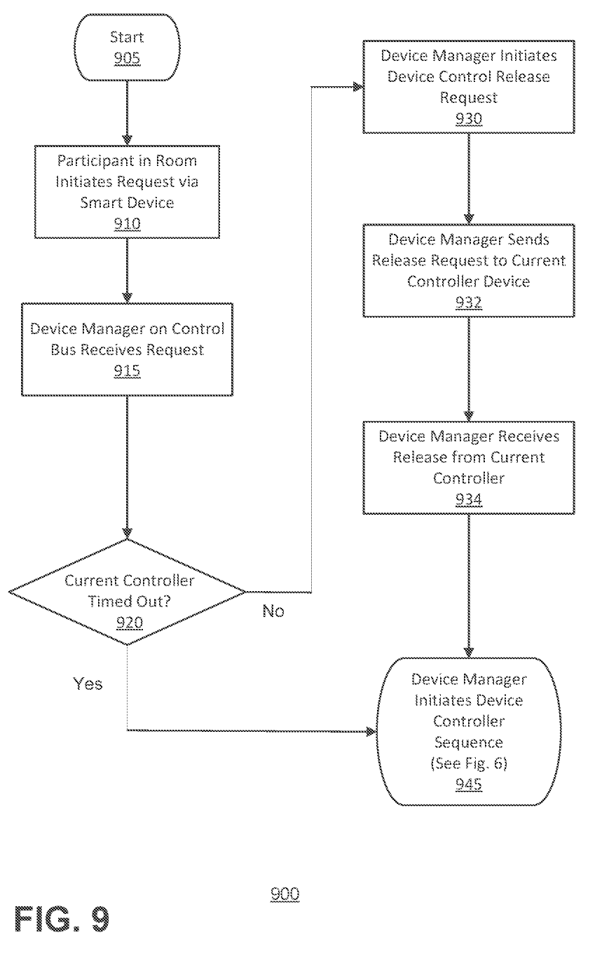

FIG. 9 is a flowchart of an embodiment of a method of device control passing of the present invention. In some embodiments of the present invention, room compute container 101 may also execute autonomous device control patterns driven by business context. As an example of an autonomous pattern that is driven by a business, facility service bus 460 may receive a command from an application, for example, to change the active camera from a day time to a night time (infrared) camera within the camera array. FIG. 8 shows the start of the process at 805. At 810, a sensor, located in a room or area where the camera area resides, for example, determines a current value and communicates that, through the facility service bus 460, to the environmental control system (ECS) 218 at step 815. The ECS determines that a change is required at 820, and at 825, transmits the necessary setting changes (e.g., to the camera array to turn the day time camera off and the infrared camera on) back through the facility service bus 460 to the device(s) that needs to change, before the process ends at 830. This pattern illustrates how interactions between devices, sensors and applications can be orchestrated through the platform.

FIG. 9 illustrates the capability at 900 in some embodiments of the present invention, for room compute container 101 to allow a new device to become the active controller when the current controller has been inactive for a period of time. A second person collaborating with the room or area's primary occupant or other occupant can, on entering an area with a smart device can make a request via a downloaded app to take over as the controller. After the process starts at 905, the actor in the room or area initiates a request via a smart device at 910. Device control is managed via the control manager provided as a service by the system software. As noted previously, this capability could be self-contained within an appliance or it could be a cloud-provided virtual service. The device manager on the control manager receives the request for control at 915. At 920, the room compute container 101 checks the current control device activity and sees that it is inactive or timed out. Room compute container 101 then allows the new device to take control of room compute container 101 within the context of the room or area, at 945, where the device manager 665A initiates the device controller sequence of FIG. 6. If the current controller is not timed out at 920, then the device manager 665A initiates a device control release request at 930, and sends the release request to the current controller device at 932. Once the device manager 665A receives the release from the current controller device at 934, it then proceeds to 945 to initiate the device controller sequence of FIG. 6 as noted above. This process 900 assumes that the new user's device is registered with the platform and with room compute container 101, the user has been properly authorized in accordance with the security features of the system manager administration component 220 and that the new user's device has downloaded the mobile app on to the smart device 165.

In some embodiments of the present invention, the presence of a wide array of devices such as sensors, lighting control, shades/blinds control, temperature control, and camera array across the facility, leads to multiple protocols and transport mechanisms for communication between them. These protocols may vary from device to device (e.g. BACnet, TCP-IP, vendor proprietary) and service to service (e.g. SOAP/REST/TCP over IP etc.). One of the capabilities of the solution is to ensure the smooth switching/conversion from one protocol to another protocol. The device gateway will be used for the protocol conversion at the device layer. The facility service bus will be utilized for the protocol conversion of the facility infrastructure services. The enterprise service bus will be utilized for the protocol conversion of the enterprise infrastructure services.

In some embodiments of the present invention, a smart hospital facility, for example, will have a number of services working together and the facility service bus may be the glue that binds the various facility infrastructure services together. In some embodiments of the present invention, a facility service bus may be employed to transfer data and dispatch workloads across the services of the entire facility. It also handles the distinguishing factors such as whether the communication is synchronous or asynchronous, is based on pub/sub or message queue base approach, and whether or not delivery guarantees are required.

In some embodiments of the present invention, duties of an enterprise service bus (ESB) 365 include: the monitor and control routing of message exchange between services; resolution of contention between communicating service components; control of deployment and versioning of services; marshalling use of redundant services and providing commodity services like event handling, data transformation and mapping, message and event queuing and sequencing, security or exception handling, protocol conversion and enforcing proper quality of communication services.

Service bus 474A is a distributed infrastructure used for integration. In some embodiments of the present invention, service bus 474A consists of a set of service containers, which integrate various types of IT assets. Containers are a type of writeable software technology that wraps a piece of software in a complete filesystem that contains everything needed to run: code, runtime, system tools, system libraries, basically anything that can be installed on a server. When enclosed in a container, the software installed in the container will run in a predicable manner, regardless of the underlying operating environment or if the container is moved from one operating environment to another. A software container includes an application and its dependencies, but shares the operating system kernel with other software containers, where each software container is running as isolated processes in user space on a host operating system. In some embodiments of the present invention, Docker (http://www.docker.com), an open source application software container technology, may be used as a reference implementation for software containerization. Docker containers as used in some embodiments of the present invention are not tied to any specific infrastructure: the containers may run on any computer, on any infrastructure, or in any cloud computing environment. The containers are interconnected with a reliable messaging bus. Service containers adapt IT assets to a standard services model, based on XML message exchange using standardized message exchange patterns. The ESB provides services for transforming, orchestrating, mediating and routing messages as well as the ability to centrally administer the distributed system.

In some embodiments of the present invention, service bus 474A provides a number of system services including routing functions including: (1) acting as a single point of entry for all the messages coming from the enterprise service bus; (2) routing the data from the enterprise infrastructure bus to the facility compute environment; (3) mediating the message between the various facility infrastructure services; (4) decoupling the various facility infrastructure services and this decoupling allows integration of disparate and diverse services; (4) acting as a gateway for messages going out of the facility compute environment; and (5) services to handle dissemination of messages and commands to the appropriate applications and application instances.

For protocol management, service bus 474A manages the presence of wide array of devices such as sensors, lighting control, shades control, temperature control, audio, video display capabilities and camera array etc. across the facility, and negotiates the multiple protocols and transport mechanisms for communication between them. These protocols may vary from device to device (BACnet, WebRTC, Vendor Proprietary) and service to service (SOAP/REST/TCP over IP etc.). One of the capabilities of the converged service computing platform is to ensure the smooth switching/conversion from one protocol to another protocol. This capability will enable the interoperability and seamless exchange of information between devices and system which are on disparate and diverse protocols. Below is the list of some of the protocols that may exists inside the smart facility.

Device Oriented Protocols:

BACNET (Building Automation & Controls Network): It is a data communications protocol, an agreed upon set of communication rules in order to standardize the communication between building automation system components (HVAC, boilers, lights, etc.).

MQTT (Message Queue Telemetry Transport): Lightweight TCP based protocols meant for device to device communication. Supports pub/sub with varying Quality of Service levels. Supports TSL/SSL encryption.

XMPP (Extensible Messaging & Presence Protocol): It is a communication protocol for message oriented middleware based on XML. TCP-based protocol that supports pub/sub and request-response. TSL/SSL communication.

Web RTC (Web Real-Time Communication): It supports applications for voice calling, video chat, and P2P file sharing without the need of either internal or external plugins.

SIP (Session Initiation Protocol): The session initiation protocol is an application layer protocol used for streaming communication and is commonly used to place VOIP calls.

Vendor Proprietary Protocols: e.g. CresNet (used by Crestron to facilitate communication between the devices of Crestron Inc.)

Service/System Oriented Protocols:

HTTP/HTTPS (Hyper Text Transfer Protocol) is a standardized protocol for all the transmission over the web and the most application API's (API's driven communication). SSL encryption.

WebSockets is session-based communications over TCP that maintains an open communication to poll for data. Meant for real-time synchronous communication. TSL/SSL encryption. This can be used for connecting human to devices via web-browsers.

FTP (File Transfer Protocols): It is a standard network protocol to transfer computer files between the client and the server.

Proprietary and other protocols may be dependent on the specific device manufacturers.

The expected implementation will be on a service bus. However, the patent application covers implementation using a local device gateway solution as well. In some embodiments of the present invention, message mediation, transformation and aggregation transforms the messages from one format to another format, e.g. from proprietary to standard format or industry standards and vice-versa. Message mediation also includes the ability to aggregate messages from disparate sources.

Orchestration is another service provided by the service bus in some embodiments of the present invention. As an example, when a sensor detects changes to the temperature or lighting in the room, that is communicated to the environmental control application which can then compare with the user's preference from the Profile and Preference system. If the temperature or lighting needs adjustment, commands are sent back to the room controllers to make the appropriate adjustments.

In some embodiments of the present invention, the service bus includes a message bus that supports data models, the command set, and a messaging infrastructure to allow different systems to communicate through a shared set of messaging interfaces.

Publish/Subscribe is supported in the service bus in some embodiments of the present invention. Publishers characterize published messages into classes without knowledge of subscribers. Subscribers register interest in one or more classes and only receive messages that are of interest, without knowledge of publishers. Both topic based and content based filtering of content is supported.

API Management is supported in the service bus for some embodiments of the present invention. An API Management service manages the publishing, documenting and monitoring of application programming interfaces (APIs) in a secure, scalable environment.

The service bus in some embodiments of the present invention supports service security, which provides for the secure connection to and use of APIs, queues and topics. The organization's security policies and patterns are implemented within the service bus security capabilities.

In some embodiments of the present invention, the service bus provides API endpoint support for synchronous and asynchronous transport protocols, service mapping (locating and binding).

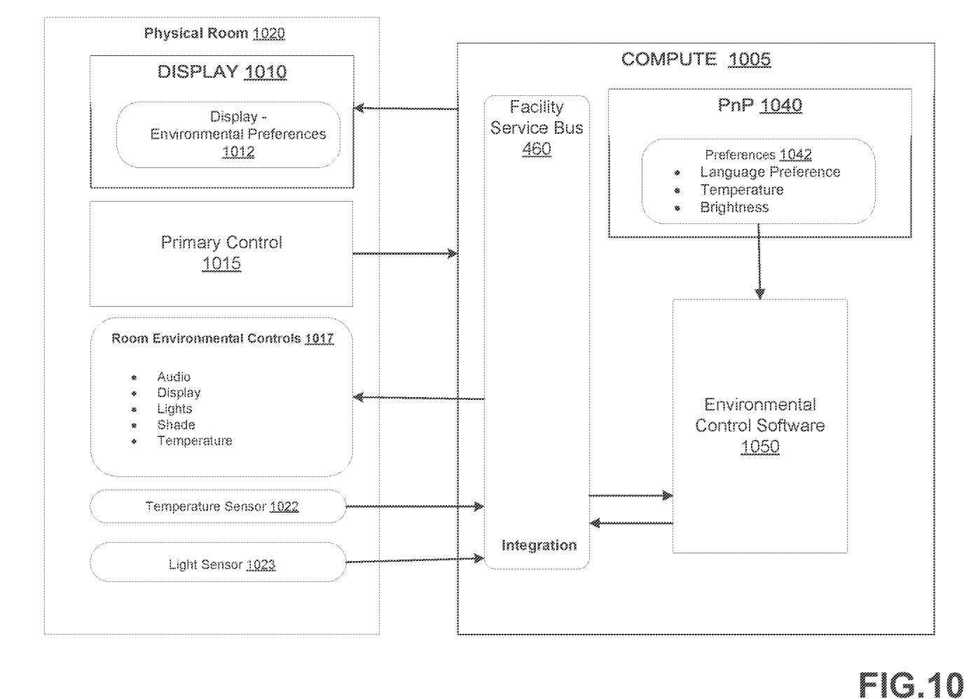

FIG. 10 shows an exemplary embodiment of how a facility service bus 460 used in some embodiments of the present invention will be leveraged inside a facility. In some embodiments of the present invention, facility service bus 460 runs in a data center compute container 1005, and acts as a data router between physical room 1020 (and an associated room compute container 101 and environmental control software 1050, which may include a number of enterprise level business services, such as building automation systems such as Desigo-Siemens or Crestron, or electronic medical records (EMR) such as Kaiser Permanente Health Connect. These are connected through facility service bus 460 to profile and preferences application services 1040, such as preferences 1042 which includes user preferences for temperature, lighting/brightness, and language. This personalization service is a component of the platform and may work with the enterprise level external business services 1050 to store and apply personal patient preferences to set the controls 1015, such as room environmental controls 1017, or provide video feed or settings to display 1010 and display environmental preferences 1012. Facility service bus 460 performs any protocol switching/handling, if needed, between the components of room compute container 101 and the enterprise level external business services 1050. For example, temperature sensor 1022 and light sensor 1023 in room 1020 may be guided by control logic executed by compute resource 1005 to adjust lighting, temperature, window shade positioning, etc. in accordance with user preferences or instructions. Facility service bus 460 acts as a glue between the room level controls and the services around the facility that are provided by the different vendors for setting up the environmental preferences. Since there are multiple vendors that may be on their own proprietary communication/message format, facility service bus 460 can perform the needed message transformation from one format to another or can conform to the open communication standards. Additionally, these vendor services may be on different protocols and the facility service bus protocol switching can perform seamless protocol conversion.

Vendor supplied applications and devices may be integrated into the platform on multiple levels. At the lowest level, vendor applications may be deployed onto a platform infrastructure. In various embodiments of the present invention, the platform infrastructure may be locally or remotely installed on servers or on an engineered hardware appliance such as CSA 150A, or running on public, private or hybrid cloud infrastructure. The platform relies on vendor software products that expose APIs. Such APIs exposed by vendor software product may or may not be based on industry and/or open standards. Furthermore, especially in the case of devices, the communications protocols employed may vary (e.g. Bluetooth, Zigbee, MQQT, etc.). In some embodiments of the present invention, the service bus will provide translation and transformation services and protocol management to these different APIs. Some embodiments of the present invention may include one or more pre-defined modules that will transform vendor APIs (as they are defined and implemented) into a standard API for CSA 150A. Some embodiments of the present invention include tools on the service bus for users to define their own API transformations. The service bus also includes a common set of APIs on which to build the UI in some embodiments of the present invention.

While the present invention has been particularly described with respect to the illustrated embodiments, it will be appreciated that various alterations, modifications and adaptations may be made based on the present disclosure, and are intended to be within the scope of the present invention. While the invention has been described in connection with what are presently considered to be the most practical and preferred embodiments, it is to be understood that the present invention is not limited to the disclosed embodiments but, on the contrary, is intended to cover various modifications and equivalent arrangements included within the scope of the appended claims.

What is claimed is:

1. A room computing system having a plurality of devices comprising at least one in-room active control device and at least one in-room passive sensor control device located in a room of a facility, comprising:
a. a network connection to one or more application services, including a profile and preference management service for a user of the room, wherein the one or more application services are communicatively coupled through a network to an enterprise infrastructure services bus; and
b. a room compute container further comprising:
i. a network endpoint connected to the plurality of room devices;
ii. a control manager communicatively connected to both: (1) the network endpoint through a control switch operable to allow only one in-room active or passive device at any given time to control the room computing system, and (2) the network connection to the one or more application services;
iii. a processor communicatively coupled to the control manager and the network connection; and
iv. a memory connected to the processor operable to store profile and preference data of the user.

2. The room computing system of claim 1, wherein the at least one in-room active control device comprises a bed speaker control, a video monitor with at least one user input device, a monitor with touch screen capabilities, a tablet device with touch screen capabilities, smart phone or other portable network-enabled computing device through a native, virtual desktop or browser-based application.

3. The room computing system of claim 1, wherein the at least one in-room passive sensor control device comprises a biometric sensor, an environmental sensor, an in-room video camera, or in-room environmental controls including temperature controls, lighting controls, or motion controls.

4. The room computing system of claim 1, wherein the room compute container comprises a physical appliance which is installed in the room of the facility.

5. The room computing system of claim 1, wherein the room compute container comprise a virtual machine instance of a cloud computing infrastructure supplied to the facility.

6. A virtual computing platform comprising a plurality of virtual machine instances of claim 5, wherein a new user initiates a new virtual machine instance in the cloud computing infrastructure, and a user discharge from the facility deletes the virtual machine instance in the cloud computing infrastructure.

7. The room computing system of claim 1, wherein the one or more application services further comprises one or more health care services, including one or more of the following: medical record; pharmacy interaction; charting; and admission, discharge, transfer (ADT) services.

8. The room computing system of claim 1, wherein the one or more application services further comprises one or more event management services, including one or more of the following: alerts, alarms, and complex event processing (CEP) services.

9. The room computing system of claim 1, wherein the one or more application services are provided through application programming interfaces (APIs).

10. The room computing system of claim 1, wherein the network endpoint connections may be accessed via hardwire network cabling, Wi-Fi or Bluetooth.

11. The room computing system of claim 1, wherein the profile and preference management service activates at least one in-room active control device and at least one in-room passive sensor control device in accordance with the user's profile and preference data.

12. The room computing system of claim 11, wherein the user profile data comprises patient name, patient care team information, and at least one room control setting.

13. The room computing system of claim 12, wherein the at least one room control setting comprises fall detection sensor activation.

14. The patient room computing system of claim 11, wherein preference data comprises one or more of the following: lighting settings, temperature settings, display settings, and entertainment settings.

15. A method of transferring control of a converged service computing system to a user device, the method comprising:
a. maintaining a device context, a device manager and a listener at an in-facility area controller;
b. assigning the listener to the device manager;
c. receiving a control request at the device manager, wherein the request is initiated by the user device;
d. sending a device object for the user device and the device context to the listener;
e. initiating a device session and session handler for the user device;
f. receiving and forwarding messages specific to the user device at the session handler; and
g. closing the device session and session handler if the session handler receives a close request.

16. The method of claim 15, further comprising:
after receiving the control request at the device manager, checking whether the current controller is timed out.

17. The method of claim 16, further comprising:
if the current controller is not timed out, initiating a device control release request;
sending the device control release request to the current controller; and
receiving a release authorization from the current controller.

18. The method of claim 16, further comprising:
If the current controller is timed out, verifying that the device session and session handler for the timed-out controller is closed.

19. A method of adding a device to a converged service computing system comprising a control manager, a network endpoint, and an administration application, the method comprising:
a. receiving device type and configuration data corresponding to the device from the administration application at the control manager;
b. if the device type is a control type, registering the device type as control;
c. discovering and registering any device APIs corresponding to the device type and configuration data;
d. receiving a communication from the device at the control manager;
e. receiving an allowed device type request from the network endpoint; and
f. if the device is allowed, requesting addition of the device to the network endpoint; and
g. reporting the device location to the administration application.

20. A method of autonomously changing a status of a device based on a sensor in a converged service computing system comprising a facility service bus, the method comprising:
a. receiving at the facility service bus a current value from the sensor, wherein the sensor is located at an area assigned to the converged service computing system;
b. transmitting the current value of the sensor to a control system;
c. receiving at the facility service bus a device setting change request from the control system; and
d. transmitting the device setting change request to the device.

21. A converged service computing system comprising:
a. a network connection to one or more application services, including a user profile and preference management service, wherein the one or more application services are communicatively coupled to an enterprise service bus and a facility service bus; and
b. a room compute container further comprising:
i. a network endpoint connected to the plurality of devices;
ii. a control manager communicatively connected to both: (1) the network endpoint through a control switch operable to allow a user device to control the converged service computing system, and (2) the network connection to the one or more application services;
iii. a processor communicatively coupled to the control manager and the network connection; and
iv. a memory connected to the processor operable to store user profile and preference data.

22. The converged service computing system of claim 21, wherein the facility service bus comprises data communications with building automation systems to control and sense lighting, window blind position, and room temperature.

23. The converged service computing system of claim 21, wherein the enterprise service bus comprises data communications with long term analytics, identity and access management services, and user data records.

24. The converged service computing system of claim 21, wherein the enterprise service bus and the facility service bus are implemented together in one physical location.

25. The converged service computing system of claim 21, wherein the enterprise service bus and the facility service bus are implemented in a cloud infrastructure at one or more physical locations.
